(19) United States
(12) Patent Application Publication
(10) Pub. No.: US 2024/0362517 A1
(43) Pub. Date: Oct. 31, 2024

(54) UNIVARIATE SERIES TRUNCATION POLICY USING CHANGEPOINT DETECTION

(71) Applicant: Oracle International Corporation, Redwood Shores, CA (US)

(72) Inventors: Ankit Aggarwal, Mumbai (IN); Chirag Ahuja, Delhi (IN); Jie Xing, Redmond, WA (US); Michal Piotr Prussak, Kirkland, WA (US)

(73) Assignee: Oracle International Corporation, Redwood Shores, CA (US)

(21) Appl. No.: 18/138,930

(22) Filed: Apr. 25, 2023

(51) Int. Cl. G06N 20/00

(52) U.S. Cl. CPC G06N 20/00

(57) ABSTRACT

Techniques described herein are directed toward univariate series truncation policy using change point detection. An example method can include a device determining a first time series comprising a first set of data points indexed over time. The device can determine a first and second change point of the first time series based on a relative position and a category of the change points. The device can generate a first and second truncated time series based on the change points. The device can generate a first and second forecasted value using a first forecasting technique. The device can compare the first forecasted value and the second forecasted value using a second time series. The device can select one of the forecasting techniques to generate a final forecasted value based on the comparison. The device can generate, using the selected first forecasting technique, the final forecasted value.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others. In many instances, a cloud services provider can offer on-demand services, such as forecasting services.

### BRIEF SUMMARY

Embodiments described herein are directed toward univariate series truncation policy using change point detection. One embodiment includes a method for univariate series truncation policy using change point detection. The method includes a computing system determining a first time series comprising a first set of data points.

The method can further include the computing system determining a first change point of the first time series based at least in part on a first relative position of the first change point in the first time series and a category of the first change point.

The method can further include the computing system determining a second change point of the first time series based at least in part on a second relative position of the second change point in the first time series and a category of the second change point.

The method can further include the computing system generating a first truncated time series based at least in part on the first change point, the first truncated time series comprising a first subset of data points of the first time series ranging from the first change point to the youngest data point of the first time series.

The method can further include the computing system generating a second truncated time series based at least in part on the second change point, the second truncated time series comprising a second subset of data points of the first time series ranging from the second change point to the youngest data point of the first time series.

The method can further include the computing system generating a first forecasted value using a first forecasting technique.

The method can further include generating a second forecasted value using a second forecasting technique.

The method can further include generating a second forecasted value using a second forecasting technique.

The method can further include comparing the first forecasted value and the second forecasted value using a second time series.

The method can further include selecting the first forecasting technique or the second forecasting technique to generate a final forecasted value based at least in part on the comparison.

The method can further include generating, using the selected first forecasting technique or second forecasting technique, the final forecasted value.

Embodiments can further include a computing system, including one or more processors and a computer-readable medium including instructions that, when executed by the one or more processors, can cause the performance of operations including determining a first time series comprising a first set of data points.

The instructions that, when executed by the one or more processors, can further cause performance of operations including determining a first change point of the first time series based at least in part on a first relative position of the first change point in the first time series and a category of the first change point.

The instructions that, when executed by the one or more processors, can further cause performance of operations including determining a second change point of the first time series based at least in part on a second relative position of the second change point in the first time series and a category of the second change point.

The instructions that, when executed by the one or more processors, can further cause performance of operations including generating a first truncated time series based at least in part on the first change point, the first truncated time series comprising a first subset of data points of the first time series ranging from the first change point to the youngest data point of the first time series.

The instructions that, when executed by the one or more processors, can further cause performance of operations including generating a second truncated time series based at least in part on the second change point, the second truncated time series comprising a second subset of data points of the first time series ranging from the second change point to the youngest data point of the first time series.

The instructions that, when executed by the one or more processors, can further cause performance of operations including generating a first forecasted value using a first forecasting technique.

The instructions that, when executed by the one or more processors, can further cause performance of operations including generating a second forecasted value using a second forecasting technique.

The instructions that, when executed by the one or more processors, can further cause performance of operations including generating a second forecasted value using a second forecasting technique.

The instructions that, when executed by the one or more processors, can further cause performance of operations including comparing the first forecasted value and the second forecasted value using a second time series.

The instructions that, when executed by the one or more processors, can further cause performance of operations including selecting the first forecasting technique or the second forecasting technique to generate a final forecasted value based at least in part on the comparison.

The instructions that, when executed by the one or more processors, can further cause performance of operations including generating, using the selected first forecasting technique or second forecasting technique, the final forecasted value.

Embodiments can further include a non-transitory computer-readable medium including stored thereon instructions that, when executed by one or more processors, causes the one or more processors to perform operations including determining a first time series comprising a first set of data points.

The instructions that, when executed by the one or more processors, can further cause performance of operations including determining a first change point of the first time series based at least in part on a first relative position of the first change point in the first time series and a category of the first change point.

The instructions that, when executed by the one or more processors, can further cause performance of operations including determining a second change point of the first time series based at least in part on a second relative position of the second change point in the first time series and a category of the second change point.

The instructions that, when executed by the one or more processors, can further cause performance of operations including generating a first truncated time series based at least in part on the first change point, the first truncated time series comprising a first subset of data points of the first time series ranging from the first change point to the youngest data point of the first time series.

The instructions that, when executed by the one or more processors, can further cause performance of operations including generating a second truncated time series based at least in part on the second change point, the second truncated time series comprising a second subset of data points of the first time series ranging from the second change point to the youngest data point of the first time series.

The instructions that, when executed by the one or more processors, can further cause performance of operations including generating a first forecasted value using a first forecasting technique.

The instructions that, when executed by the one or more processors, can further cause performance of operations including generating a second forecasted value using a second forecasting technique.

The instructions that, when executed by the one or more processors, can further cause performance of operations including generating a second forecasted value using a second forecasting technique.

The instructions that, when executed by one or more processors, can further cause performance of operations including comparing the first forecasted value and the second forecasted value using a second time series.

The instructions that, when executed by the one or more processors, can further cause performance of operations including selecting the first forecasting technique or the second forecasting technique to generate a final forecasted value based at least in part on the comparison.

The instructions that, when executed by the one or more processors, can further cause performance of operations including generating, using the selected first forecasting technique or second forecasting technique, the final forecasted value.

### BRIEF DESCRIPTION OF THE DRAWINGS

FIG. 1 is an illustration of a forecasting system using changepoint-based truncation, according to one or more embodiments.

FIG. 2 is an illustration of an example table of identified change points, according to one or more embodiments.

FIG. 3 is an illustration of an example table for normalized position scores, according to one or more embodiments.

FIG. 4 is an illustration of an example table of normalized category scores, according to one or more embodiments.

FIG. 5 is an illustration of a table for normalized overall score, according to one or more embodiments.

FIG. 6 is an illustration of a table for normalized overall score, according to one or more embodiments.

FIG. 7 is an illustration of a final truncated time series, according to one or more embodiments.

FIG. 8 is a plot of a variance change point, according to one or more embodiments.

FIG. 9 is an illustration of a plot of a mean change point, according to one or more embodiments.

FIG. 10 is an illustration of a plot of a trend change point, according to one or more embodiments.

FIG. 11 is a process flow for truncating a time series based on a change point, according to one or more embodiments.

FIG. 12 is a block diagram illustrating one pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating another pattern for implementing a cloud infrastructure as a service system, according to at least one embodiment.

FIG. 16 is a block diagram illustrating an example computer system, according to at least one embodiment.

### DETAILED DESCRIPTION

In the following description, various embodiments will be described. For purposes of explanation, specific configurations and details are set forth to provide a thorough understanding of the embodiments. However, it will also be apparent to one skilled in the art that the embodiments may be practiced without the specific details. Furthermore, well-known features may be omitted or simplified in order not to obscure the embodiment being described.

Organizations can use time series to understand the behavior of measured values over a period of time. In some instances, once an organization's computing system can identify patterns in the time series, the time series can be used to forecast values for future dates. Change point detection is a process of detecting changes in a property (e.g., trends, frequencies, or probability distribution) of a time series. A change point detection algorithm (e.g., window-based segmentation, binary segmentation, bottom-up segmentation, pruned extract linear time, and exact segmentation dynamic programming) can be used to identify the borders between changes in the time series. For example, a weather monitoring system can monitor daily temperatures of a location A, which is generally a hot region. A sudden cold spell in location A can cause the average daily temperature to drop by a noticeable amount resulting in a period of time with lower than normal average temperatures. A computing system can use a change point detection technique to identify a first change point in the time series, in which the average temperature in location A is reduced to a lower than normal average and a second change point, in which the temperature in location A returns to the normal average temperature.

One issue that can arise for computing system tasked with forecasting is that forecasting values using a large times-series can be slow as fitting model-parameters is generally quadratic in nature. The model can be a machine learning model that implements a forecasting technique (e.g., Prophet, double exponential smoothing, damped double exponential smoothing, deep learning, single moving average, double moving average). Two responses to slow model-fitting can be to use faster algorithms or use shorter time series. However, if a computing system chooses to truncate a time series, the forecasting accuracy can also be affected if the time series to truncated at an incorrect data point of the time series. For example, if a computing system is overly aggressive in truncating a time series, valuable data points can be lost. On the other hand, if a computing system is not aggressive enough, redundant data points from the original time series can remain in the truncated time series. Therefore, the issue is determining how far back from the youngest data point of a time series should a forecasting system move to truncate the time series.

Embodiments presented here address the above-referenced issues by providing a methodology for selecting an optimal change point for truncating a time series and forecasting values using the truncated time series. A forecasting system can receive a time series, a set of forecasting techniques (e.g., Prophet, double exponential smoothing, damped double exponential smoothing, deep learning, single moving average, double moving average), and a request for forecasted values. The time series can be a univariate time series, such that the time series includes single observations (e.g., a single variable) recorded sequentially over time. The forecasting system can determine to truncate the time series based on the length of the time series being greater than a threshold length. The forecasting system can further determine where to truncate the time series with respect to each forecasting technique of the set of forecasting techniques. The forecasting system can select a change point detection algorithm to detect one or more change points in the time series based on the determined technique. Each change point detection algorithm can be configured to detect a respective type of change point. The desired change point type can be based on the forecasting technique to be used to forecast values. For example, the forecasting system can use a data structure that includes a mapping of forecasting techniques to change-point detection algorithms.

The forecasting system can use the change-point algorithm to identify one or more change points in the time series. Consider a situation in which the forecasting system receives a time series, a first forecasting technique and a second forecasting technique. The first forecasting technique can be amenable to a first change-point type and the second forecasting technique can be amenable to a second change-point type. The forecasting system can select a first change-point detection algorithm for detecting the first change-point type and a second change-point detection algorithm for detecting the second change-point type. The forecasting system can then use the first change-point algorithm to detect one or more first change-point types in the time series. The forecasting system can then use the second change-point algorithm to detect one or more second change-point types in the time series.

The forecasting system can then assign a score to each detected change point in the time series. The forecasting system can then truncate a first iteration of the time series based on the scores for the one or more first change point types. The forecasting system can then truncate a second iteration of the time series based on the scores for the one or more second change point types. The forecasting service can then forecast values for one or more future time steps each truncated time series using the corresponding first forecasting technique and second forecasting technique. As the selected change point is an optimal change point, the forecasting system can have confidence that the forecasted values have the same accuracy as if the system used the entire time series to forecast the values. The forecasting system can compare the accuracy of the forecasted values using the corresponding first forecasting technique and second forecasting technique. The forecasting system can then select the forecasting technique that forecast the most accurate value for fulfilling the request for forecasted values.

As indicated above, the forecasting system can score each change point, to score change points, the forecasting system can determine a technique for scoring each identified change point based on the determined forecasting technique and the change point type. The forecasting system can use the determined scoring technique to score each change point identified in the time series. The forecasting system can then select a respective change point with the highest score to be used to truncate each time series.

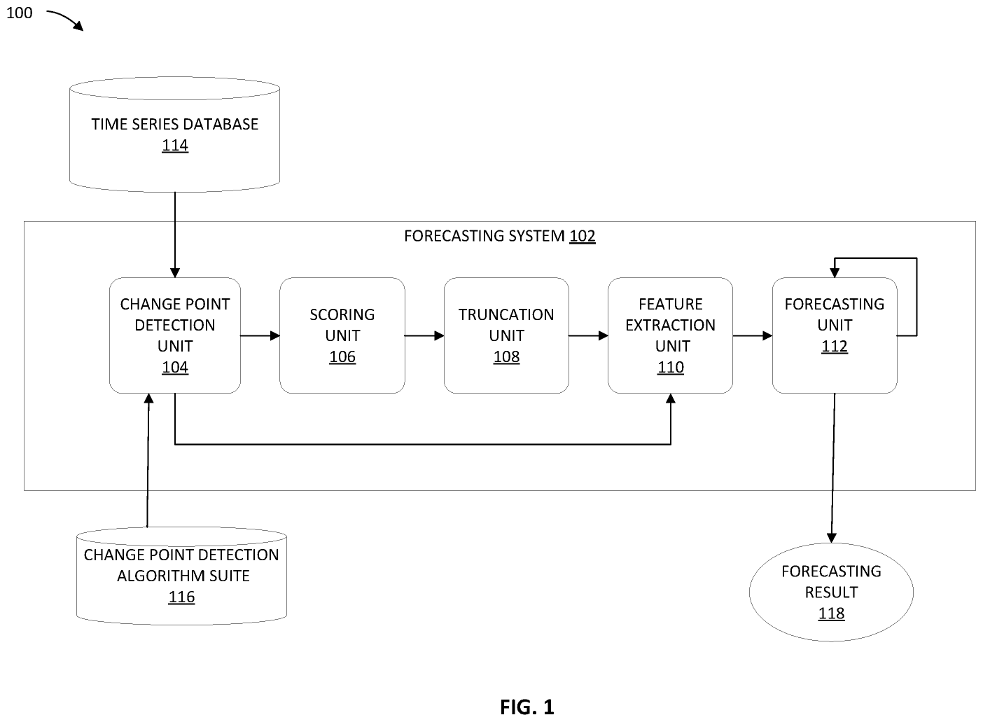

FIG. 1 is an illustration 100 of a forecasting system using change point-based truncation, according to one or more embodiments. The forecasting system 102 can include a change point detection unit 104, a scoring unit 106, a truncation unit 108, a feature extraction unit 110, and a forecasting unit 112. The forecasting system can be used be forecasting service of a cloud services provider. For example, the cloud services provider can provide one or more servers of the provider's infrastructure to implement the forecasting service.

A customer can provide a time series and a request for forecasted values for future dates. The time series can be a set of values indexed over time. The time series can be a univariate time series, such that the time series includes single observations (e.g., a single variable) recorded sequentially over time. For example, the time series can be a set of daily temperatures over a ten year period. The cloud services provider can store the time series in a time series database to be retrieved by the forecasting system 102. The time series received from the time series database can be received by the change point detection unit 104. The change point detection unit 104 can determine whether the size of the time series is greater than a threshold size. If the size of the time series is greater than the threshold size, the change point detection unit 104 can elect to determine one or more change points in the time series. If, however, the size of the time series is less than the threshold size, the change point detection unit 104 can transmit the time series to a feature extraction unit 110.

In the instance that the change point detection unit 104 determines that the size of the time series is greater than the threshold size, the time series can select two or more change point detection algorithms to detect change points in the time series. The algorithms can be offline algorithms that evaluate a time series in its entirety, as opposed to online algorithms that evaluate each data point concurrently with collecting of the data. For example, offline change point detection can include evaluating daily temperatures for the past fifteen years up to a current temperature, while online change point detection can include evaluating real-time temperature values as the temperatures are collected.

The change point detection unit 104 can split the time series into two sets a first set (e.g., training set) and a second set (e.g., test set). The training set can be used to generate preliminary forecasts, and the test set can be used to evaluate the preliminary forecasts. For example, the time series can be monthly values for cars sold in Detroit in 2020. The change point detection unit 104 can split the time series into a training set including months January through August and a test set from September through December. The change point detection unit 104 can then retrieve a set of offline change point detection algorithms that can be configured to detect different types of change points. It should be appreciated that different forecasting techniques (e.g., Prophet, autoregressive integrated moving average (ARIMA), deep learning-based forecasting, machine learning-based forecasting) prefer different types of change points. For example, a trend change point can be valuable to Prophet, double exponential trend smoothing (ETS), and damped double ETS forecasting techniques. Variance change points can be more valuable to deep learning forecasting techniques. Level change points can be more valuable to single ETS, single moving average, and double moving average forecasting techniques.

The change point detection unit 104 can use the change point detection algorithms to detect change points in the training set. In addition to detecting the change point, the change point detection unit 104 can detect the type (e.g., variance, level, trend) of the change point. The change point detection unit 104 can further use each change point detection algorithm to determine a confidence score for each detected change point. The change point detection unit 104 can further transmit the training set, the test set, and the detected change points to the scoring unit 106.

The scoring unit 106 can evaluate each change point based in a forecasting technique to select a change point to be used to truncate the time series. Each forecasting technique can include a weight and score pertaining to a change points relative position in the time series. The weight can be considered a normalized position score. Using the example above, the twelve months of the year can be indexed to positions 0-11. Each algorithm can further have a normalized position score for each indexed value. For example, for indexed value 0 (e.g., January), and machine learning-based forecasting technique can have a normalized position score of 0, whereas a deep learning-based forecasting technique can have a normalized position score of 100. Each indexed value can include a respective normalized position score. Furthermore, each forecasting technique can have a respective normalized position score for each indexed value.

As indicated above, a time series can include various different types of change points (e.g., change in mean change points, change in variance change points, change in pattern change points, and change in frequency change points). As further indicated above, different forecasting techniques have different preferences for change point types. Therefore, the scoring unit 106 can assign a score for each change point based on the change point type and the forecasting technique. For example, for a variance type change point can have category score of 100 for a machine learning-based based algorithm, and a trend type change point can have a category score of 0 for the machine learning-based forecasting technique. On the other hand, a deep learning-based forecasting technique can have different category scores from the category scores of the machine learning-based algorithm.

The scoring unit 106 can select a change point for each algorithm that has the highest normalized overall score. The normalized overall score can be using the normalized confidence score, normalized position score, and the normalized category score. For each detected change point, the scoring unit 106 can determine the average of the normalized confidence score, normalized position score, and the normalized category score to determine the normalized overall score. For example, for a Prophet forecasting technique if the change point index value is 900, the normalized confidence score can be 95, the normalized position score can be 10.87, and the normalized category score can be 100. Taking the average of the three normalized values for the Prophet forecasting technique, the normalized overall score for the change point at index value 900 can be 68.62 (e.g., ((95+10.87+100)/3)=68.62).

The scoring unit 106 can determine a respective normalized overall score for each of the detected change points and forecasting techniques. For example, the change point detection unit 104 can detect change points at index values 400, 800, 900, and 1300. The scoring unit 106 can determine a respective normalized overall score for each change point for each forecasting technique. For example, if there are two candidate forecasting techniques, exponential trend smoothing and deep learning-based forecasting techniques, the scoring unit 106 can determine a set of normalized overall scores of change points 400, 800, 900, and 1300 for exponential trend smoothing forecasting technique and another set of normalized overall scores of change points 400, 800, 900, and 1300 for the deep learning-based forecasting technique.

The scoring unit 106 can select a highest overall normalized overall score for each forecasting technique. The scoring unit 106 can then identify the change point (e.g., 400, 800, 900, or 1300) associated with the highest normalized overall score. The scoring unit 106 can then transmit the change points associated with the highest normalized overall score for each algorithm. For example, for an exponential trend smoothing forecasting technique, the highest normalized overall score can be associated with change point 400 and for a Prophet forecasting technique, the highest normalized overall score can be associated with change point 900. The scoring unit can transmit the change point 400 for the exponential trend smoothing forecasting technique and the change point 900 for the Prophet forecasting technique to the truncation unit.

The truncation unit 108 can truncate the training set based on the change points received from the scoring unit 106. In particular, the truncation unit 108 can truncate the training set from the youngest data point to the respective change point for each algorithm to generate truncated time series. For example, consider a time series of 2000 data points that has been indexed from the oldest data point to the youngest data point to index values 0-1999, where 0 is the index value of the oldest data point and 1999 is the value of the youngest data point. The time series can have further been subdivided into a training set from data point 0 to data point 1499 and a testing set from data point 1500 to data point 1999. For the exponential trend smoothing forecasting technique, the truncation unit 108 can generate a truncated time series from data point 400 to data point 1499. Additionally, for the Prophet forecasting technique, the truncation unit can generate a truncated time series from data point 900 to data point 1499.

The truncation unit 108 can transmit the truncated time series and the training set to the feature extraction unit 110 and the forecasting unit 112. The feature extraction unit 110 can extract respective features from each truncated time series based on the forecasting technique. The feature extraction unit 110 can further transmit the extracted features to be used as inputs to the forecasting unit 122 to forecast values. The forecasting unit 112 can be configured to implement multiple forecasting techniques (e.g., exponential trend smoothing and Prophet). The forecasting unit 112 can further forecast values using each forecasting techniques. The forecasting unit 112 can further use the testing set to evaluate the forecasted values. The forecasting unit 112 can then compare the evaluation of the forecasted values and select the forecasting technique with the lowest error. For example, the forecasting unit can use the truncated time series and forecast predicted values for indexed data points 1500 to 1599 using the exponential trending smoothing algorithm and the Prophet. The forecasting unit 112 can then compare the predicted values for data points 1500 to 1599 with the actual values from data points 1500 to 1599 using the real values from the testing set. Whichever of the exponential trend smoothing forecasting technique or the Prophet forecasting technique has the fewest error can be selected to generate the final forecasted values.

The forecasting unit 112 can generate a final truncated time series by adding the testing set to the truncated time series of the selected forecasting technique. The forecasting unit 112 can use the selected forecasting technique and final time series to forecast values. For example, consider the exponential smoothing algorithm having the least error using the truncated time series. The forecasting unit 112 can generate a final truncated time series by combining the truncated time series (e.g., data point 400 to data point 1499) and the testing set (e.g., data point 1500 to data point 1999) to generate a final truncated time series (e.g., data point 400 to data point 1999). The forecasting unit 112 can then use the final truncated time series to generate a forecasting result 114, including forecasted values for future time steps.

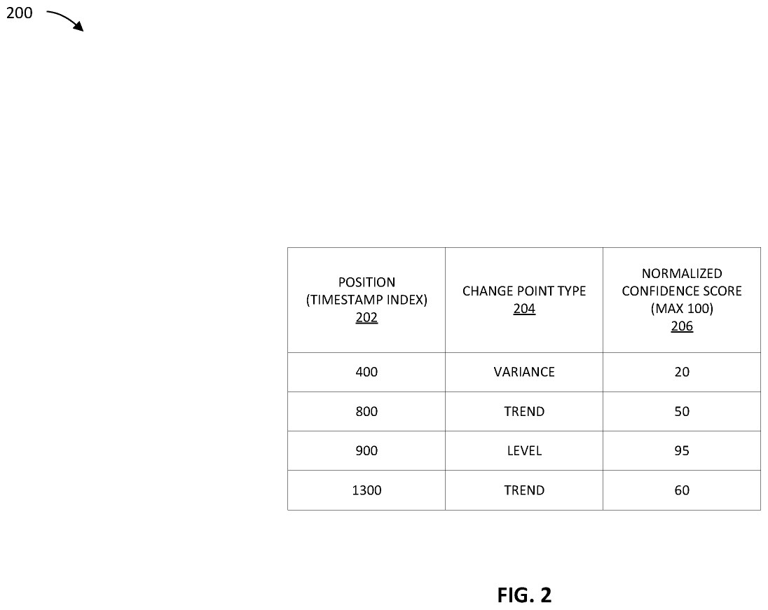

FIG. 2 is an illustration of an example table of identified change points, according to one or more embodiments. FIGS. 2-6 describe the above process with example values. For an example context, a forecasting system (e.g., the forecasting system 102 of FIG. 1) has received a time series of length 1500, or in other words, 1500 data points. The data points can include daily measured values for a first parameter (e.g., wind intensity for the past 1500 days). The forecasting system has further received control instructions to forecast values for the next 50 days in the future. The time series has been subdivided into a training set of 1400 data points (e.g., indexed values 0-1399) and a testing set of 100 data points (e.g., indexed values 1400-1499). The forecasting system can further be tasked with selecting a change point to generate a final truncated time series and a forecasting technique from a set of forecasting techniques including Prophet, ARIMA, ETS, seasonal, deep learning-based (DL), machine learning-based (ML), and a moving average (MA) forecasting technique.

As illustrated in FIG. 2, a change point detection unit (e.g., the change point detection unit 104 of FIG. 1) of the forecasting system has used one or more change point detection algorithms to determine four change points and identify the change points by index position 202. As illustrated, the index positions are 400, 800, 900, and 1300. The change point detection unit can identify a change point type 204 for each identified change point. For example, for change points 800 and 1300 the identified type is a trend change point. The change point detection unit can further use the change point detection algorithm to determine a normalized confidence score 206 for each change point. For example, the normalized confidence score for change point 800 is 50.

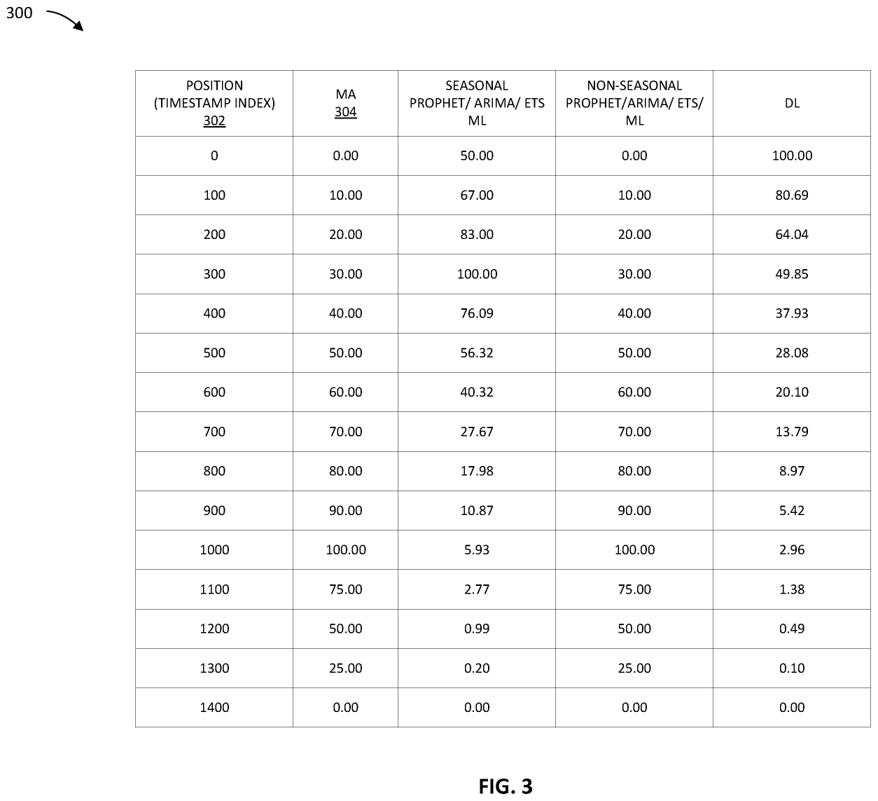

FIG. 3 is an illustration 300 of an example table for normalized position scores, according to one or more embodiments. The table includes a column for index position 302. The table further includes respective normalized position scores for each index position for each forecasting technique. As illustrated, the normalized position scores are based on the index position and the forecasting technique. The Prophet, ARIMA, ETS, and ML forecasting techniques are further divided into seasonal types and non-seasonal types. For illustration, consider the moving average (MA) column 304. The table provides normalized position scores for change points at positions 0-1400. It can be seen from the MA column 304 that the MA forecasting technique places an increasing preference for change points at position 0-1000, where the preference is 0 at change point at position 0 and increases to 100 at a change point at position 1000. The MA forecasting technique exhibits a decreasing preference for change points at positions 1000 to 1400. It can further be seen that the non-seasonal Prophet, ARIMA, ETS, and ML forecasting techniques exhibit the same as the MA forecasting technique preferences. It can further be seen that the DL and seasonal Prophet, ARIMA, ETS, and ML forecasting techniques exhibit different preferences as to the change points. It should be appreciated that although FIG. 3 illustrates data point positions in 100 data point position increments, a different position column can include different position increments (e.g., increments of 1, 5, 50, and so forth).

It can be seen that identified change points can be preferred to different degrees based on the change point's relative position and the forecasting technique. For example, a moving average (MA) forecasting technique can have a highest normalized position score at change point at position 1000, whereas a seasonal Prophet forecasting technique can have a highest normalized position score at change point at position 302. The variances can be based on the data each forecasting technique uses to reach the most accurate results. As each forecasting technique has its own set of calculations, each forecasting technique can use input data differently and need different input data to get accurate results.

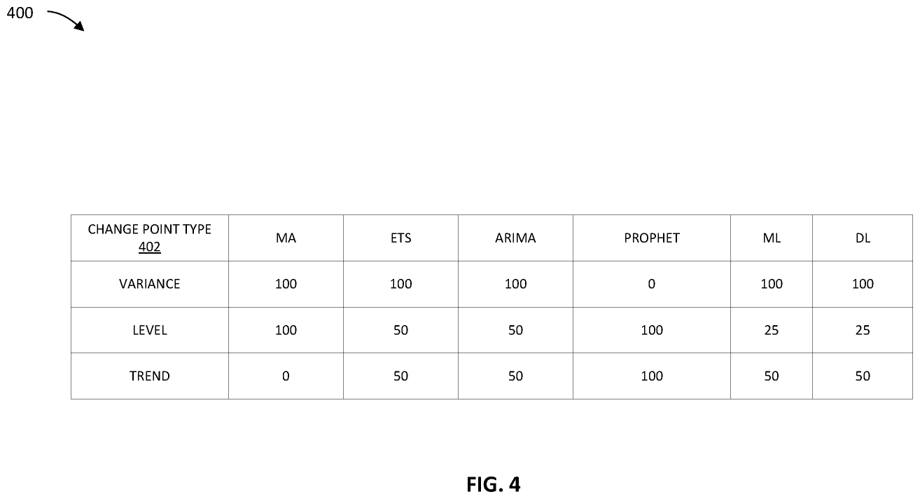

FIG. 4 is an illustration of an example table of normalized category scores, according to one or more embodiments. The table includes a column 402 for change point type, such as variance, level, and trend. It should be appreciated that there are additional change point types, and the table is illustrative of the example used for FIGS. 2-6. The table further includes columns for different forecasting techniques, including a moving average (MA), exponential trend smoothing (ETS), autoregressive integrated moving average (ARIMA), Prophet, machine learning-based (ML), and deep learning (DL). It should also be appreciated that there are additional forecasting techniques, and the illustrated algorithms are in conformity with the example used for FIGS. 2-6. As illustrated, each forecasting technique has preferences as to a change point type. For example, for the exponential trend smoothing (ETS) forecasting technique, the normalized category score for a variance type change point is 100, while for the Prophet forecasting technique, the normalized category score is 0. Furthermore, each forecasting technique prefers different types of change points. For example, for the exponential trend smoothing (ETS) forecasting technique, the normalized category score for a variance type change point is 100, while the normalized category score for a level or trend type change point is 50.

It can be seen that different forecasting techniques prefer different change point categories. The differing preferences can be based on the data each forecasting technique uses to reach the most accurate results. A change point category can be more meaningful to one forecasting technique than another forecasting technique for generating accurate results. As each forecasting technique has its own set of calculations, each forecasting technique can use input data differently and need different input data to get accurate results.

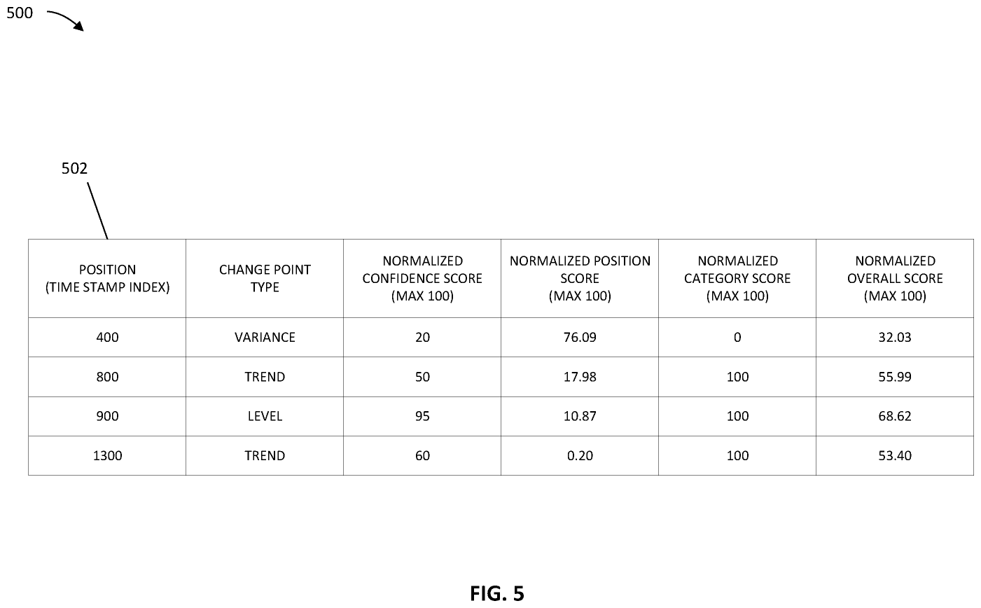

FIG. 5 is an illustration of a table for normalized overall score, according to one or more embodiments. As indicated above, a scoring unit (e.g., the scoring unit 106 of FIG. 1) can determine the normalized overall score based on the normalized confidence score, normalized position score, and normalized category score. In particular, the scoring unit can determine an average of the three normalized score as the normalized overall score. The table 502 illustrated in FIG. 5 relates to scores for the Prophet forecasting technique. As illustrated, each of the identified change points at positions 400, 800, 900, and 1300 are presented. As an illustration, consider the change point at position 400. Change point at position 400 is a variance type change point. The change point detection algorithm that identified the change point can have determined a confidence score of 20. The normalized position score can be based on the relative position of the change point and the forecasting technique and have a value of 76.09. The normalized category score can be based on the category type and the forecasting technique and have a value of 0. The normalized overall score can be an average of these three normalized scores and have a value of 32.03 (e.g., ((20+76.09+0)/3)=32.03). The scoring unit can similarly determine overall change point scores for change points at positions 800, 900, and 1300. Based on the illustrated table values, the highest normalized overall score can be associated with change point 900.

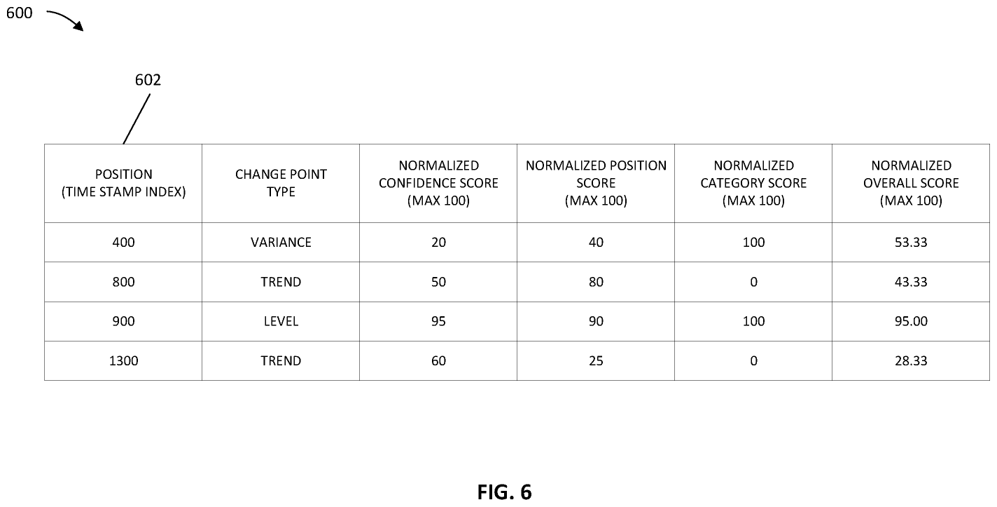

FIG. 6 is an illustration of a table for normalized overall score, according to one or more embodiments. As indicated above, a scoring unit (e.g., the scoring unit 106 of FIG. 1) can determine the normalized overall score based on the normalized confidence score, normalized position score, and normalized category score. In particular, the scoring unit can determine an average of the three normalized score as the normalized overall score. The table 602 illustrated in FIG. 6 relates to scores for the moving average (MA) forecasting technique. As seen, each of the identified change points at positions 400, 800, 900, and 1300 are presented. Consider again the change point at position 900. The change point detection algorithm that identified the change point can have determined a confidence score of 95. The normalized position score can be based on the relative position of the change point and the forecasting technique and have a value of 90. The normalized category score can be based on the category type and the forecasting technique and have a value of 100. The normalized overall score can be an average of these three normalized scores and have a value of 95 (e.g., ((95+90+100)/3)=95). The scoring unit can similarly determine overall change point scores for change points at positions 400, 800, and 1300. The scoring unit can further determine normalized overall scores for the change points at positions 400, 800, 900, and 1300 with respect to each other forecasting technique (e.g., exponential trend smoothing (ETS), autoregressive integrated moving average (ARIMA), machine learning-based (ML), and deep learning (DL).

The scoring unit can transmit change points associated with the highest normalized overall scores, the training set (e.g., indexed values 0-1399) and the testing set (e.g., indexed values 1400-1499) to a feature extraction unit and a forecasting unit (e.g., the feature extraction unit 110 and the forecasting unit 112 of FIG. 1). For example, for both the Prophet forecasting technique and the moving average (MA) forecasting technique, the scoring unit can transmit the change point 900, the training set, and the testing set. It should be appreciated that for the forecasting techniques, the scoring unit may send changes points at positions 400, 800, or 1300 based on the normalized overall scores. The forecasting unit can create truncated time series and forecast future values. For example, for both the Prophet forecasting technique and the moving average (MA) forecasting technique, the truncated time series can be data points 900-1399. The forecasting unit can respectively forecast predicted values using the truncated time series and each forecasting technique. The forecasting unit can further compare the predicted values with the actual values from the testing set to determine which forecasting technique forecasts values with the least error. For example, the time series can be daily coffee sales and the data point indexed at 1399 can be for Jul. 1, 2022, coffee sales. The forecasting unit can forecast a value for Jul. 2, 2022, using the truncated time series and each forecasting techniques. The forecasting unit can then compare the predicted value generated using the forecasting techniques and the real Jul. 2, 2022, coffee sales from the testing set (e.g., indexed data point at position 1400). The forecasting technique that most accurately forecasts a value compared to the real value can be selected to generate final forecasting values. To generate the final forecasting values, the forecasting unit can generate a final truncated time series by combining the truncated time series of the selected forecasting technique and the testing set. For example, if the moving average forecasting technique is selected, the truncated time series can be data points at positions 900 to 1399 and the testing set can be data points at positions 1400 to 1499. Therefore, the truncated time series can be data points at positions 900 to 1499. This final truncated time series can be used to forecast values for future dates.

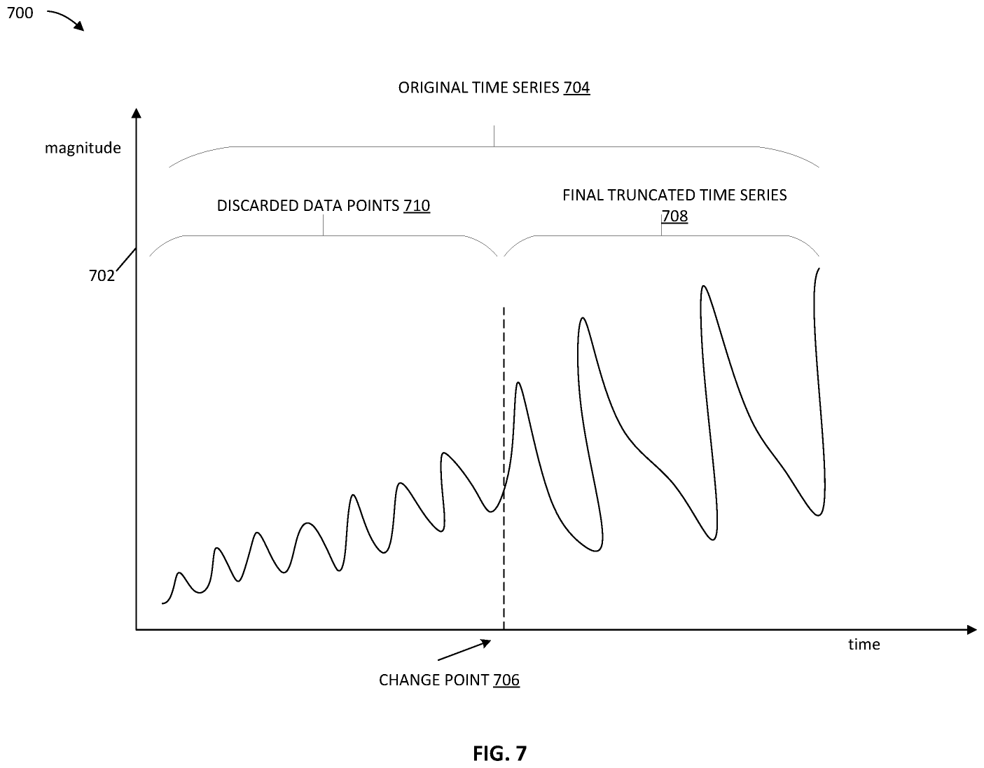

FIG. 7 is an illustration 700 of a final truncated time series, according to one or more embodiments. As illustrated, a plot of magnitude over time is shown. A customer can have provided an original time series 704 and a forecasting service of a cloud service provider can use a forecasting system to perform the above described steps. The original time series 704 can be a univariate time series, such that the time series includes single observations (e.g., single variable) recorded sequentially over time. The forecasting system can select a forecasting technique and change point 706 based on a normalized overall score. The forecasting system can further discard the data points that occur prior to the change point 706. The discarded data points 710 are illustrated as occurring prior in time to the change point 706. The forecasting system can further generate a final truncated time series by combining a truncated time series using for training and a testing set. The forecasting unit can further use the final truncated time series to generate forecasted values. It should be appreciated that based on the above-described method for selecting a change point, the accuracy of the forecasted values using the final truncated time series versus using the original time series is preserved. Furthermore, given the truncation of the original time series 704, the forecasting service can reduce the time required for model fitting. Model fitting can include generating a simplified representation of the time series. The greater the number of data points, the longer time is required to generate the simplified representation, and therefore reducing the number of data points reduces the time required for model fitting. Furthermore, given the reduction in data points, fewer compute resources (e.g., processors, applications, services, . . . ) can be dedicated to the model fitting process. Even further, the time that the compute resources are dedicated to the model fitting process can be reduced given the fewer number of data points. Therefore, the herein described process assists in freeing resources to be used to perform tasks other than a model fitting process, and also reduces the amount of time that resources are used for the model fitting process.

It should be appreciated that the herein described embodiments can result in higher accuracy for forecasted values. The accuracy can be based on properly truncating a time series. As described above, selecting the incorrect truncation point can lead to either discarding too few or too many data points and as a result, reduced accuracy. The herein described embodiments describe a forecasting technique-based change point selection process for truncating a time series. By truncating the time series at an optimal change point, the herein described process can result in an improved accuracy and/or reduced error with respect to forecasted values.

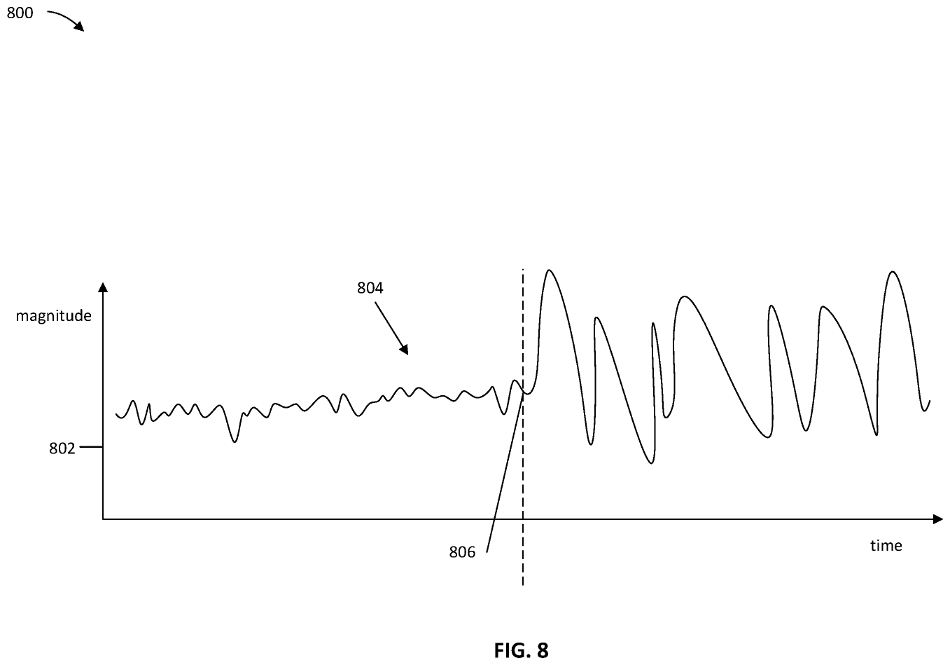

As indicated above, there are different categories of change points. FIGS. 8-10 illustrate some different categories of change points. FIG. 8 is an illustration of a plot 802 of a variance change point, according to one or more embodiments. As illustrated, a time series 804 includes a waveform representative of a magnitude of a parameter over time. A change point detection algorithm has identified a change point 806. The category of the change point 806 can be a variance change point. It can be seen that the data points to the left of the change point 806 have a smaller variance than the data points to the right of the change point 806.

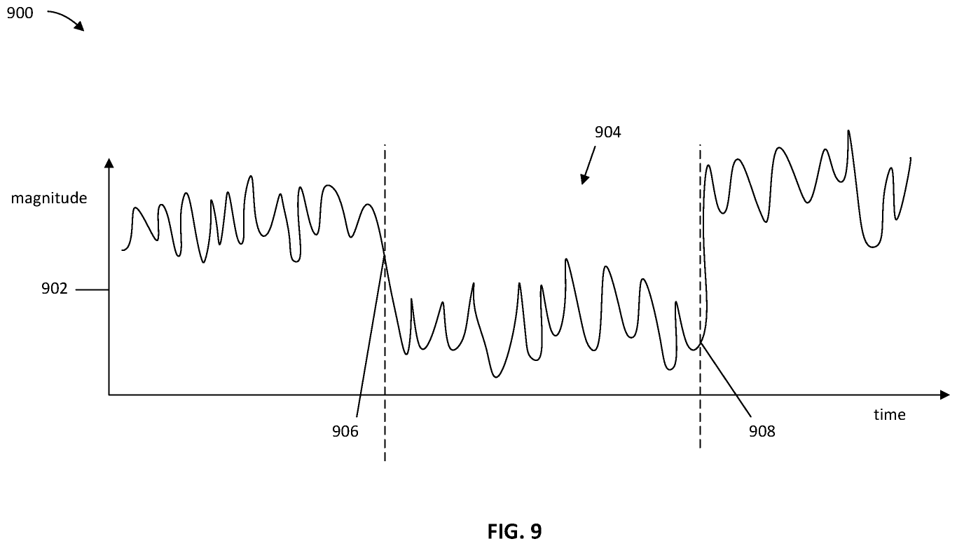

FIG. 9 is an illustration 900 of a plot 902 of a mean change point, according to one or more embodiments. It can be seen that the time series 904 resembles a set of three segments having different mean values. A change point detection algorithm can detect a first change point 906 and a second change point 908. As seen, a mean of the values of the data points to the time series 904 drop when passing the first change point 906 and rise when passing the second change point 908.

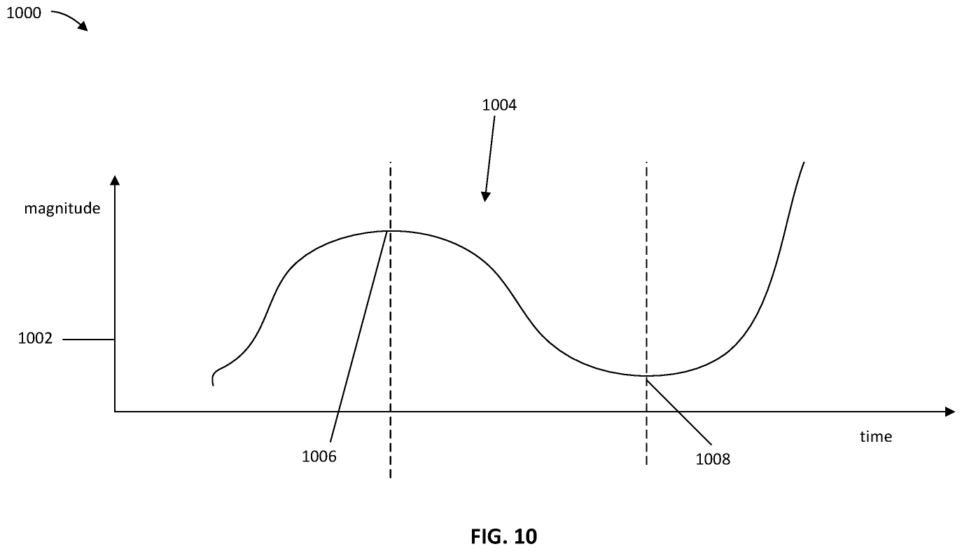

FIG. 10 is an illustration 1000 of a plot 1002 of a trend change point, according to one or more embodiments. The time series 1004 can resemble a series of rising and falling values. A change point detection algorithm can detect a first change point 1006 and a second change point 1008. At seen the values can shift from rising to falling while passing the first change point 1006. As further seen, the values can shift from falling to rising while passing the second change point 1008.

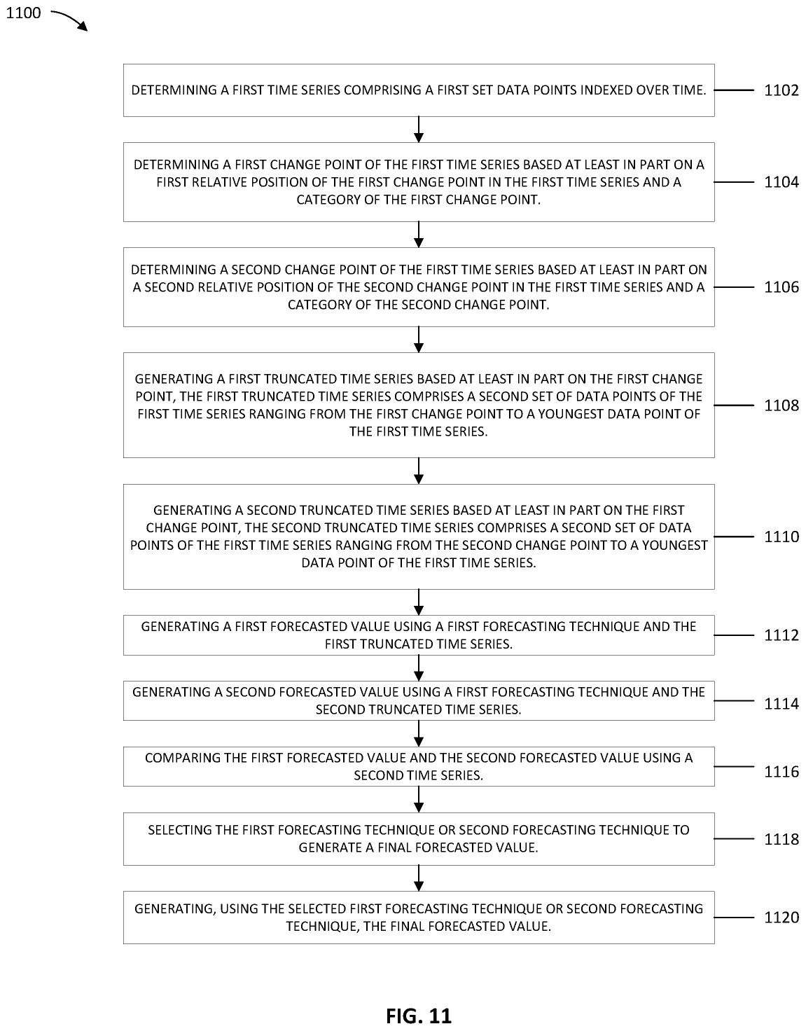

FIG. 11 is a process flow 1100 for truncating a time series based on a change point, according to one or more embodiments. While the operations of process 1100 are described as being performed by generic computers, it should be understood that any suitable device (e.g., a user device, a server device) may be used to perform one or more operations of these processes. Process 1100 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform functions or implement data types. The order in which the operations are described is not intended to be construed as a limitation, and any number of the described operations can be combined in any order and/or in parallel to implement the processes.

At 1102, the method can include a computing system determining a first time series comprising a first set of data points. The computing system can be a one or more servers of a cloud service provider. The computing system can implement a forecasting service of the cloud service provider. The first time series can be training set generated from splitting an original time series (e.g., third time series) into a first time series (training set) and a second time series (testing set). The original time series can be a univariate time series, such that the time series includes single observations (e.g., a single variable) recorded sequentially over time. The computing system can identify a data point to split the original time series at a data point based on reducing a forecasting bias. Forecasting bias can result from selecting sub-optimal data point to split the original time series. The sub-optimal data point can lead to over forecasting, in which the forecasted values are much higher than actual values, or under forecasting, in which the forecasted values are much lower than actual values.

At 1104, the method can include the computing system determining a first change point of the first time series based at least in part on a first relative position of the first change point in the first time series and a category of the first change point. The computing system can use a change point detection algorithm to detect a set of change points. Each change point can be a data point of the first time series which indicated as change in a property (e.g., trends, frequencies, or probability distributions) in the first time series. The computing system can further generate a confidence score, a relative position score, and a category score for each change point of the set of change points. The scores can be with respect to a first forecasting technique and a second forecasting technique. In other words, the confidence score, the relative position score, and the category score for a change point may or not be the same based on a forecasting technique to be used. The computing system can further identify the first change point from the set of change points by calculating an overall score and selecting the change point with the highest overall score.

At 1106, the method can include the computing system determining a second change point of the first time series based at least in part on a second relative position of the second change point in the first time series and a category of the second change point.

At 1108, the method can include the computing system generating a first truncated time series based at least in part on the first change point, the first truncated time series comprising a first subset set of data points of the first time series ranging from the first change point to the youngest data point of the first time series. The computing system can split the first time series at the first change point to generate the first truncated time series.

At 1110, the method can include the computing system generating a second truncated time series based at least in part on the second change point, the second truncated time series comprising a second subset of data points of the first time series ranging from the second change point to the youngest data point of the first time series. The computing system can split the first time series at the second change point to generate the first truncated time series. The first change point and the second change point.

At 1112, the method can include the computing system generating a first forecasted value using a first forecasting technique and the first truncated time series. The computing system can extract input features from the first truncated time series and use the first forecasting technique (e.g., Prophet, autoregressive integrated moving average (ARIMA), deep learning-based forecasting, and machine learning-based forecasting) to forecast a value.

At 1114, the method can include the computing system generating a second forecasted value using a second forecasting technique and the second truncated time series. The computing system can extract input features from the first truncated time series and use the second forecasting technique (e.g., Prophet, autoregressive integrated moving average (ARIMA), deep learning-based forecasting, and machine learning-based forecasting) to forecast a value.

At 1116, the method can include the computing system comparing the first forecasted value and the second forecasted value using a second time series. The computing system can use the second time series (e.g., testing set) to determine which forecasting technique using which change point results in the least error for the forecasted values.

At 1118, the method can include the computing system selecting the first forecasting technique or the second forecasting technique based at least in part on the comparison.

At 1120, the method can include the computing system generating using the selected forecasting technique, a final forecasted value. The final forecasted value can be returned to a customer of the cloud service provider.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

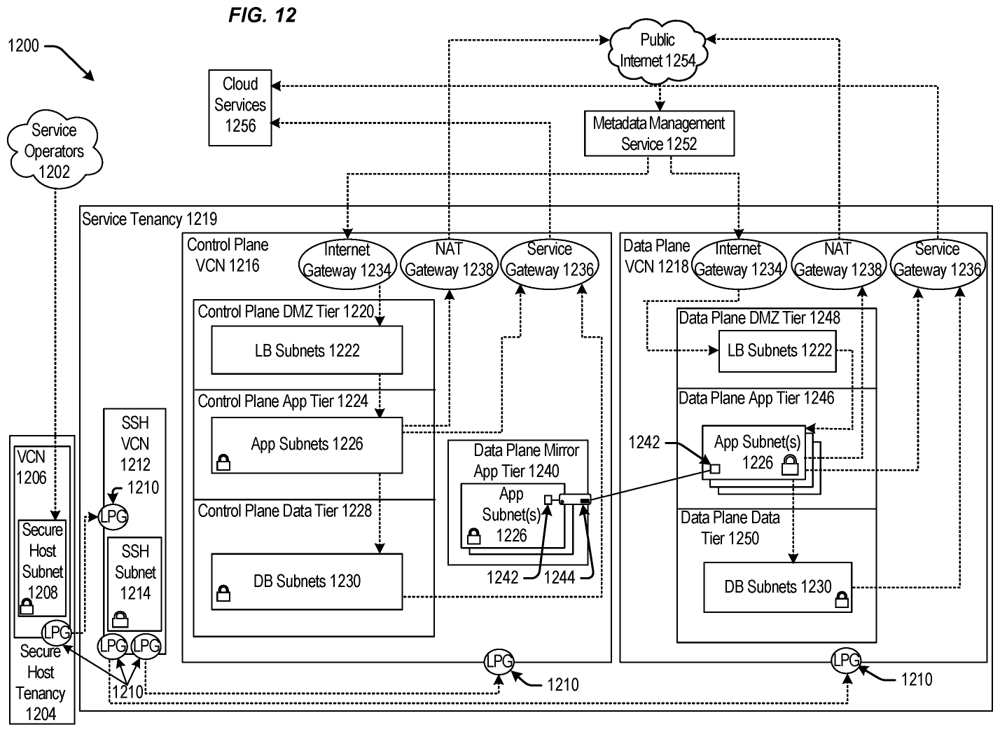

FIG. 12 is a block diagram 1200 illustrating an example pattern of an IaaS architecture, according to at least one embodiment. Service operators 1202 can be communicatively coupled to a secure host tenancy 1204 that can include a virtual cloud network (VCN) 1206 and a secure host subnet 1208. In some examples, the service operators 1202 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1206 and/or the Internet.

The VCN 1206 can include a local peering gateway (LPG) 1210 that can be communicatively coupled to a secure shell (SSH) VCN 1212 via an LPG 1210 contained in the SSH VCN 1212. The SSH VCN 1212 can include an SSH subnet 1214, and the SSH VCN 1212 can be communicatively coupled to a control plane VCN 1216 via the LPG 1210 contained in the control plane VCN 1216. Also, the SSH VCN 1212 can be communicatively coupled to a data plane VCN 1218 via an LPG 1210. The control plane VCN 1216 and the data plane VCN 1218 can be contained in a service tenancy 1219 that can be owned and/or operated by the IaaS provider.

The control plane VCN 1216 can include a control plane demilitarized zone (DMZ) tier 1220 that acts as a perimeter network (e.g., portions of a corporate network between the corporate intranet and external networks). The DMZ-based servers may have restricted responsibilities and help keep breaches contained. Additionally, the DMZ tier 1220 can include one or more load balancer (LB) subnet(s) 1222, a control plane app tier 1224 that can include app subnet(s) 1226, a control plane data tier 1228 that can include database (DB) subnet(s) 1230 (e.g., frontend DB subnet(s) and/or backend DB subnet(s)). The LB subnet(s) 1222 contained in the control plane DMZ tier 1220 can be communicatively coupled to the app subnet(s) 1226 contained in the control plane app tier 1224 and an Internet gateway 1234 that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238. The control plane VCN 1216 can include the service gateway 1236 and the NAT gateway 1238.

The control plane VCN 1216 can include a data plane mirror app tier 1240 that can include app subnet(s) 1226. The app subnet(s) 1226 contained in the data plane mirror app tier 1240 can include a virtual network interface controller (VNIC) 1242 that can execute a compute instance 1244. The compute instance 1244 can communicatively couple the app subnet(s) 1226 of the data plane mirror app tier 1240 to app subnet(s) 1226 that can be contained in a data plane app tier 1246.

The data plane VCN 1218 can include the data plane app tier 1246, a data plane DMZ tier 1248, and a data plane data tier 1250. The data plane DMZ tier 1248 can include LB subnet(s) 1222 that can be communicatively coupled to the app subnet(s) 1226 of the data plane app tier 1246 and the Internet gateway 1234 of the data plane VCN 1218. The app subnet(s) 1226 can be communicatively coupled to the service gateway 1236 of the data plane VCN 1218 and the NAT gateway 1238 of the data plane VCN 1218. The data plane data tier 1250 can also include the DB subnet(s) 1230 that can be communicatively coupled to the app subnet(s) 1226 of the data plane app tier 1246.

The Internet gateway 1234 of the control plane VCN 1216 and of the data plane VCN 1218 can be communicatively coupled to a metadata management service 1252 that can be communicatively coupled to public Internet 1254. Public Internet 1254 can be communicatively coupled to the NAT gateway 1238 of the control plane VCN 1216 and of the data plane VCN 1218. The service gateway 1236 of the control plane VCN 1216 and of the data plane VCN 1218 can be communicatively couple to cloud services 1256.

In some examples, the service gateway 1236 of the control plane VCN 1216 or of the data plane VCN 1218 can make application programming interface (API) calls to cloud services 1256 without going through public Internet 1254. The API calls to cloud services 1256 from the service gateway 1236 can be one-way: the service gateway 1236 can make API calls to cloud services 1256, and cloud services 1256 can send requested data to the service gateway 1236. But, cloud services 1256 may not initiate API calls to the service gateway 1236.

In some examples, the secure host tenancy 1204 can be directly connected to the service tenancy 1219, which may be otherwise isolated. The secure host subnet 1208 can communicate with the SSH subnet 1214 through an LPG 1210 that may enable two-way communication over an otherwise isolated system. Connecting the secure host subnet 1208 to the SSH subnet 1214 may give the secure host subnet 1208 access to other entities within the service tenancy 1219.

The control plane VCN 1216 may allow users of the service tenancy 1219 to set up or otherwise provision desired resources. Desired resources provisioned in the control plane VCN 1216 may be deployed or otherwise used in the data plane VCN 1218. In some examples, the control plane VCN 1216 can be isolated from the data plane VCN 1218, and the data plane mirror app tier 1240 of the control plane VCN 1216 can communicate with the data plane app tier 1246 of the data plane VCN 1218 via VNICs 1242 that can be contained in the data plane mirror app tier 1240 and the data plane app tier 1246.

In some examples, users of the system, or customers, can make requests, for example create, read, update, or delete (CRUD) operations, through public Internet 1254 that can communicate the requests to the metadata management service 1252. The metadata management service 1252 can communicate the request to the control plane VCN 1216 through the Internet gateway 1234. The request can be received by the LB subnet(s) 1222 contained in the control plane DMZ tier 1220. The LB subnet(s) 1222 may determine that the request is valid, and in response to this determination, the LB subnet(s) 1222 can transmit the request to app subnet(s) 1226 contained in the control plane app tier 1224. If the request is validated and requires a call to public Internet 1254, the call to public Internet 1254 may be transmitted to the NAT gateway 1238 that can make the call to public Internet 1254. Metadata that may be desired to be stored by the request can be stored in the DB subnet(s) 1230.

In some examples, the data plane mirror app tier 1240 can facilitate direct communication between the control plane VCN 1216 and the data plane VCN 1218. For example, changes, updates, or other suitable modifications to configuration may be desired to be applied to the resources contained in the data plane VCN 1218. Via a VNIC 1242, the control plane VCN 1216 can directly communicate with, and can thereby execute the changes, updates, or other suitable modifications to configuration to, resources contained in the data plane VCN 1218.

In some embodiments, the control plane VCN 1216 and the data plane VCN 1218 can be contained in the service tenancy 1219. In this case, the user, or the customer, of the system may not own or operate either the control plane VCN 1216 or the data plane VCN 1218. Instead, the IaaS provider may own or operate the control plane VCN 1216 and the data plane VCN 1218, both of which may be contained in the service tenancy 1219. This embodiment can enable isolation of networks that may prevent users or customers from interacting with other users', or other customers', resources. Also, this embodiment may allow users or customers of the system to store databases privately without needing to rely on public Internet 1254, which may not have a desired level of threat prevention, for storage.

In other embodiments, the LB subnet(s) 1222 contained in the control plane VCN 1216 can be configured to receive a signal from the service gateway 1236. In this embodiment, the control plane VCN 1216 and the data plane VCN 1218 may be configured to be called by a customer of the IaaS provider without calling public Internet 1254. Customers of the IaaS provider may desire this embodiment since database(s) that the customers use may be controlled by the IaaS provider and may be stored on the service tenancy 1219, which may be isolated from public Internet 1254.

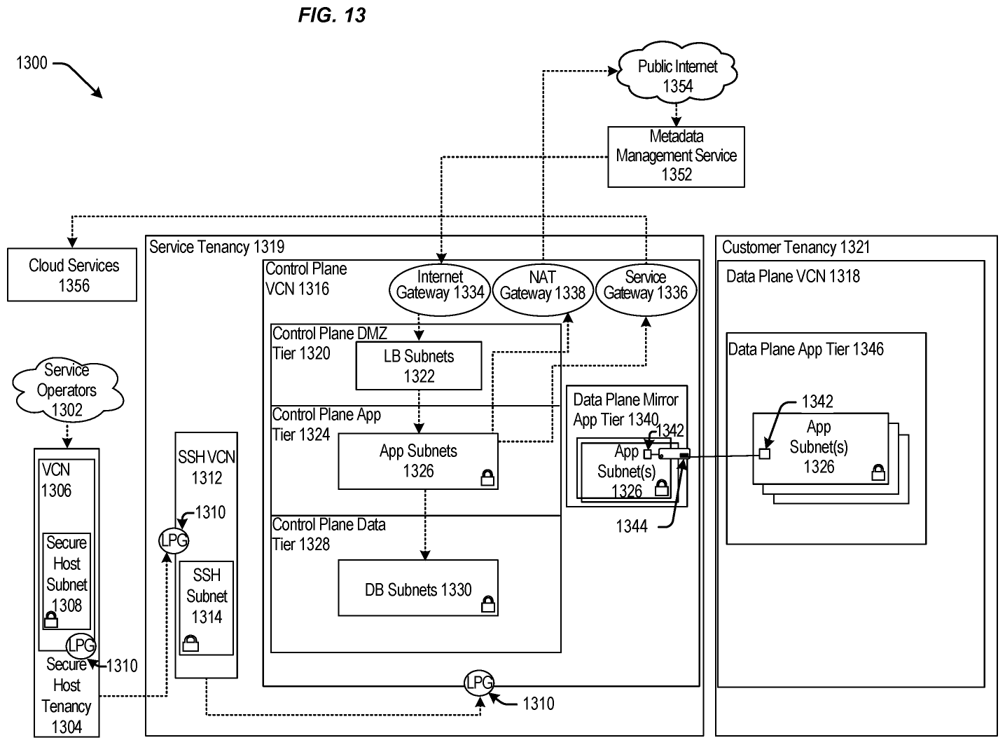

FIG. 13 is a block diagram 1300 illustrating another example pattern of an IaaS architecture, according to at least one embodiment. Service operators 1302 (e.g., service operators 1202 of FIG. 12) can be communicatively coupled to a secure host tenancy 1304 (e.g., the secure host tenancy 1204 of FIG. 12) that can include a virtual cloud network (VCN) 1306 (e.g., the VCN 1206 of FIG. 12) and a secure host subnet 1308 (e.g., the secure host subnet 1208 of FIG. 12). The VCN 1306 can include a local peering gateway (LPG) 1310 (e.g., the LPG 1210 of FIG. 12) that can be communicatively coupled to a secure shell (SSH) VCN 1312 (e.g., the SSH VCN 1212 of FIG. 12) via an LPG 1210 contained in the SSH VCN 1312. The SSH VCN 1312 can include an SSH subnet 1314 (e.g., the SSH subnet 1214 of FIG. 12), and the SSH VCN 1312 can be communicatively coupled to a control plane VCN 1316 (e.g., the control plane VCN 1216 of FIG. 12) via an LPG 1310 contained in the control plane VCN 1316. The control plane VCN 1316 can be contained in a service tenancy 1319 (e.g., the service tenancy 1219 of FIG. 12), and the data plane VCN 1318 (e.g., the data plane VCN 1218 of FIG. 12) can be contained in a customer tenancy 1321 that may be owned or operated by users, or customers, of the system.

The control plane VCN 1316 can include a control plane DMZ tier 1320 (e.g., the control plane DMZ tier 1220 of FIG. 12) that can include LB subnet(s) 1322 (e.g., LB subnet(s) 1222 of FIG. 12), a control plane app tier 1324 (e.g., the control plane app tier 1224 of FIG. 12) that can include app subnet(s) 1326 (e.g., app subnet(s) 1226 of FIG. 12), a control plane data tier 1328 (e.g., the control plane data tier 1228 of FIG. 12) that can include database (DB) subnet(s) 1330 (e.g., similar to DB subnet(s) 1230 of FIG. 12). The LB subnet(s) 1322 contained in the control plane DMZ tier 1320 can be communicatively coupled to the app subnet(s) 1326 contained in the control plane app tier 1324 and an Internet gateway 1334 (e.g., the Internet gateway 1234 of FIG. 12) that can be contained in the control plane VCN 1316, and the app subnet(s) 1326 can be communicatively coupled to the DB subnet(s) 1330 contained in the control plane data tier 1328 and a service gateway 1336 (e.g., the service gateway 1236 of FIG. 12) and a network address translation (NAT) gateway 1338 (e.g., the NAT gateway 1238 of FIG. 12). The control plane VCN 1316 can include the service gateway 1336 and the NAT gateway 1338.

The control plane VCN 1316 can include a data plane mirror app tier 1340 (e.g., the data plane mirror app tier 1240 of FIG. 12) that can include app subnet(s) 1326. The app subnet(s) 1326 contained in the data plane mirror app tier 1340 can include a virtual network interface controller (VNIC) 1342 (e.g., the VNIC of 1242) that can execute a compute instance 1344 (e.g., similar to the compute instance 1244 of FIG. 12). The compute instance 1344 can facilitate communication between the app subnet(s) 1326 of the data plane mirror app tier 1340 and the app subnet(s) 1326 that can be contained in a data plane app tier 1346 (e.g., the data plane app tier 1246 of FIG. 12) via the VNIC 1342 contained in the data plane mirror app tier 1340 and the VNIC 1342 contained in the data plane app tier 1346.

The Internet gateway 1334 contained in the control plane VCN 1316 can be communicatively coupled to a metadata management service 1352 (e.g., the metadata management service 1252 of FIG. 12) that can be communicatively coupled to public Internet 1354 (e.g., public Internet 1254 of FIG. 12). Public Internet 1354 can be communicatively coupled to the NAT gateway 1338 contained in the control plane VCN 1316. The service gateway 1336 contained in the control plane VCN 1316 can be communicatively couple to cloud services 1356 (e.g., cloud services 1256 of FIG. 12).

In some examples, the data plane VCN 1318 can be contained in the customer tenancy 1321. In this case, the IaaS provider may provide the control plane VCN 1316 for each customer, and the IaaS provider may, for each customer, set up a unique compute instance 1344 that is contained in the service tenancy 1319. Each compute instance 1344 may allow communication between the control plane VCN 1316, contained in the service tenancy 1319, and the data plane VCN 1318 that is contained in the customer tenancy 1321. The compute instance 1344 may allow resources, that are provisioned in the control plane VCN 1316 that is contained in the service tenancy 1319, to be deployed or otherwise used in the data plane VCN 1318 that is contained in the customer tenancy 1321.

In other examples, the customer of the IaaS provider may have databases that live in the customer tenancy 1321. In this example, the control plane VCN 1316 can include the data plane mirror app tier 1340 that can include app subnet(s) 1326. The data plane mirror app tier 1340 can reside in the data plane VCN 1318, but the data plane mirror app tier 1340 may not live in the data plane VCN 1318. That is, the data plane mirror app tier 1340 may have access to the customer tenancy 1321, but the data plane mirror app tier 1340 may not exist in the data plane VCN 1318 or be owned or operated by the customer of the IaaS provider. The data plane mirror app tier 1340 may be configured to make calls to the data plane VCN 1318 but may not be configured to make calls to any entity contained in the control plane VCN 1316. The customer may desire to deploy or otherwise use resources in the data plane VCN 1318 that are provisioned in the control plane VCN 1316, and the data plane mirror app tier 1340 can facilitate the desired deployment, or other usage of resources, of the customer.

In some embodiments, the customer of the IaaS provider can apply filters to the data plane VCN 1318. In this embodiment, the customer can determine what the data plane VCN 1318 can access, and the customer may restrict access to public Internet 1354 from the data plane VCN 1318. The IaaS provider may not be able to apply filters or otherwise control access of the data plane VCN 1318 to any outside networks or databases. Applying filters and controls by the customer onto the data plane VCN 1318, contained in the customer tenancy 1321, can help isolate the data plane VCN 1318 from other customers and from public Internet 1354.

In some embodiments, cloud services 1356 can be called by the service gateway 1336 to access services that may not exist on public Internet 1354, on the control plane VCN 1316, or on the data plane VCN 1318. The connection between cloud services 1356 and the control plane VCN 1316 or the data plane VCN 1318 may not be live or continuous. Cloud services 1356 may exist on a different network owned or operated by the IaaS provider. Cloud services 1356 may be configured to receive calls from the service gateway 1336 and may be configured to not receive calls from public Internet 1354. Some cloud services 1356 may be isolated from other cloud services 1356, and the control plane VCN 1316 may be isolated from cloud services 1356 that may not be in the same region as the control plane VCN 1316. For example, the control plane VCN 1316 may be located in “Region 1,” and cloud service “Deployment 12,” may be located in Region 1 and in “Region 2.” If a call to Deployment 12 is made by the service gateway 1336 contained in the control plane VCN 1316 located in Region 1, the call may be transmitted to Deployment 12 in Region 1. In this example, the control plane VCN 1316, or Deployment 12 in Region 1, may not be communicatively coupled to, or otherwise in communication with, Deployment 12 in Region 2.

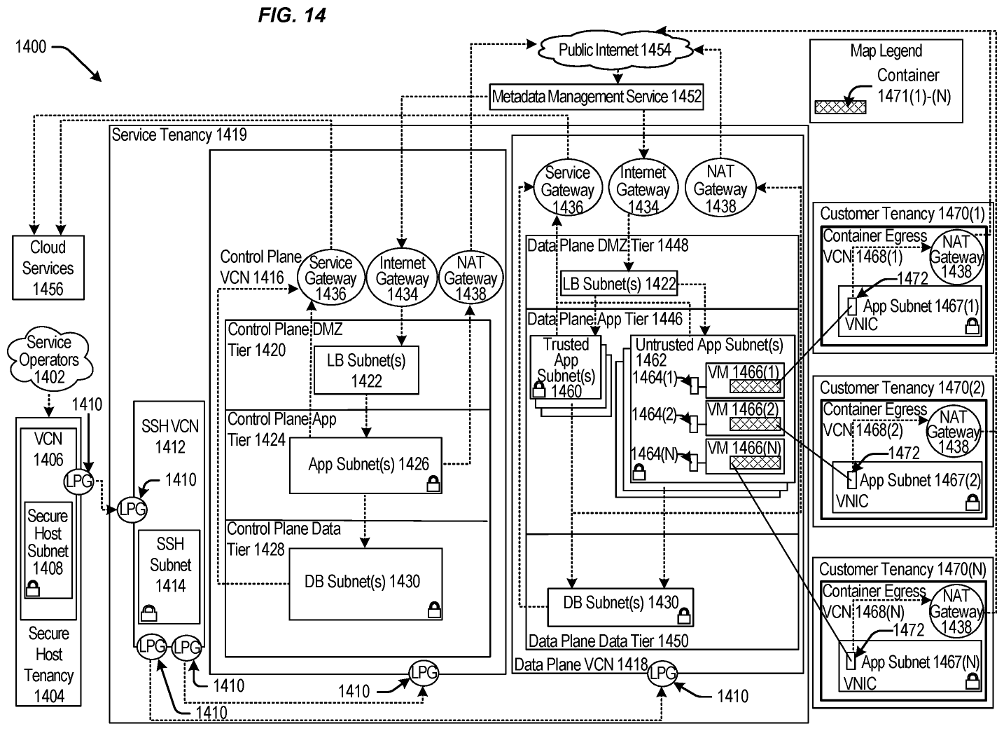

FIG. 14 is a block diagram 1400 illustrating another example pattern of an IaaS architecture, according to at least one embodiment. Service operators 1402 (e.g., service operators 1202 of FIG. 12) can be communicatively coupled to a secure host tenancy 1404 (e.g., the secure host tenancy 1204 of FIG. 12) that can include a virtual cloud network (VCN) 1406 (e.g., the VCN 1206 of FIG. 12) and a secure host subnet 1408 (e.g., the secure host subnet 1208 of FIG. 12). The VCN 1406 can include an LPG 1410 (e.g., the LPG 1210 of FIG. 12) that can be communicatively coupled to an SSH VCN 1412 (e.g., the SSH VCN 1212 of FIG. 12) via an LPG 1410 contained in the SSH VCN 1412. The SSH VCN 1412 can include an SSH subnet 1414 (e.g., the SSH subnet 1214 of FIG. 12), and the SSH VCN 1412 can be communicatively coupled to a control plane VCN 1416 (e.g., the control plane VCN 1216 of FIG. 12) via an LPG 1410 contained in the control plane VCN 1416 and to a data plane VCN 1418 (e.g., the data plane 1218 of FIG. 12) via an LPG 1410 contained in the data plane VCN 1418. The control plane VCN 1416 and the data plane VCN 1418 can be contained in a service tenancy 1419 (e.g., the service tenancy 1219 of FIG. 12).

The control plane VCN 1416 can include a control plane DMZ tier 1420 (e.g., the control plane DMZ tier 1220 of FIG. 12) that can include load balancer (LB) subnet(s) 1422 (e.g., LB subnet(s) 1222 of FIG. 12), a control plane app tier 1424 (e.g., the control plane app tier 1224 of FIG. 12) that can include app subnet(s) 1426 (e.g., similar to app subnet(s) 1226 of FIG. 12), a control plane data tier 1428 (e.g., the control plane data tier 1228 of FIG. 12) that can include DB subnet(s) 1430. The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1234 of FIG. 12) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 12) and a network address translation (NAT) gateway 1438 (e.g., the NAT gateway 1238 of FIG. 12). The control plane VCN 1416 can include the service gateway 1436 and the NAT gateway 1438.

The data plane VCN 1418 can include a data plane app tier 1446 (e.g., the data plane app tier 1246 of FIG. 12), a data plane DMZ tier 1448 (e.g., the data plane DMZ tier 1248 of FIG. 12), and a data plane data tier 1450 (e.g., the data plane data tier 1250 of FIG. 12). The data plane DMZ tier 1448 can include LB subnet(s) 1422 that can be communicatively coupled to trusted app subnet(s) 1460 and untrusted app subnet(s) 1462 of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include one or more primary VNICs 1464(1)-(N) that can be communicatively coupled to tenant virtual machines (VMs) 1466(1)-(N). Each tenant VM 1466(1)-(N) can be communicatively coupled to a respective app subnet 1467(1)-(N) that can be contained in respective container egress VCNs 1468(1)-(N) that can be contained in respective customer tenancies 1470(1)-(N). Respective secondary VNICs 1472(1)-(N) can facilitate communication between the untrusted app subnet(s) 1462 contained in the data plane VCN 1418 and the app subnet contained in the container egress VCNs 1468(1)-(N). Each container egress VCNs 1468(1)-(N) can include a NAT gateway 1438 that can be communicatively coupled to public Internet 1454 (e.g., public Internet 1254 of FIG. 12).

The Internet gateway 1434 contained in the control plane VCN 1416 and contained in the data plane VCN 1418 can be communicatively coupled to a metadata management service 1452 (e.g., the metadata management system 1252 of FIG. 12) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some embodiments, the data plane VCN 1418 can be integrated with customer tenancies 1470. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1446. Code to run the function may be executed in the VMs 1466(1)-(N), and the code may not be configured to run anywhere else on the data plane VCN 1418. Each VM 1466(1)-(N) may be connected to one customer tenancy 1470. Respective containers 1471(1)-(N) contained in the VMs 1466(1)-(N) may be configured to run the code. In this case, there can be a dual isolation (e.g., the containers 1471(1)-(N) running code, where the containers 1471(1)-(N) may be contained in at least the VM 1466(1)-(N) that are contained in the untrusted app subnet(s) 1462), which may help prevent incorrect or otherwise undesirable code from damaging the network of the IaaS provider or from damaging a network of a different customer. The containers 1471(1)-(N) may be communicatively coupled to the customer tenancy 1470 and may be configured to transmit or receive data from the customer tenancy 1470. The containers 1471(1)-(N) may not be configured to transmit or receive data from any other entity in the data plane VCN 1418. Upon completion of running the code, the IaaS provider may kill or otherwise dispose of the containers 1471(1)-(N).

In some embodiments, the trusted app subnet(s) 1460 may run code that may be owned or operated by the IaaS provider. In this embodiment, the trusted app subnet(s) 1460 may be communicatively coupled to the DB subnet(s) 1430 and be configured to execute CRUD operations in the DB subnet(s) 1430. The untrusted app subnet(s) 1462 may be communicatively coupled to the DB subnet(s) 1430, but in this embodiment, the untrusted app subnet(s) may be configured to execute read operations in the DB subnet(s) 1430. The containers 1471(1)-(N) that can be contained in the VM 1466(1)-(N) of each customer and that may run code from the customer may not be communicatively coupled with the DB subnet(s) 1430.

In other embodiments, the control plane VCN 1416 and the data plane VCN 1418 may not be directly communicatively coupled. In this embodiment, there may be no direct communication between the control plane VCN 1416 and the data plane VCN 1418. However, communication can occur indirectly through at least one method. An LPG 1410 may be established by the IaaS provider that can facilitate communication between the control plane VCN 1416 and the data plane VCN 1418. In another example, the control plane VCN 1416 or the data plane VCN 1418 can make a call to cloud services 1456 via the service gateway 1436. For example, a call to cloud services 1456 from the control plane VCN 1416 can include a request for a service that can communicate with the data plane VCN 1418.

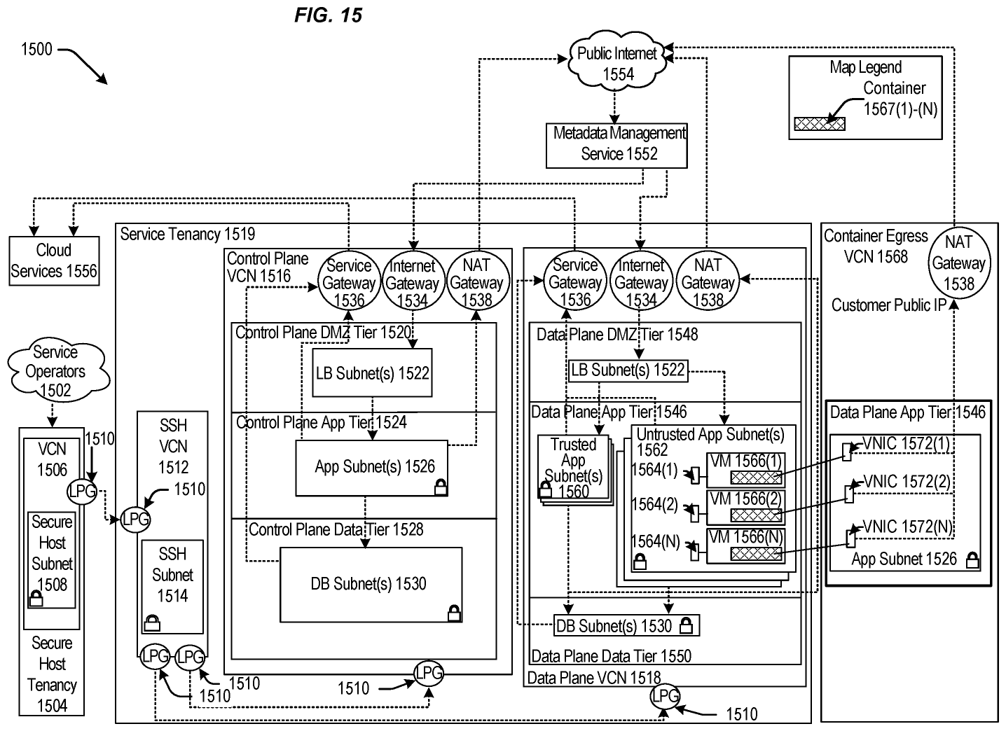

FIG. 15 is a block diagram 1500 illustrating another example pattern of an IaaS architecture, according to at least one embodiment. Service operators 1502 (e.g., service operators 1202 of FIG. 12) can be communicatively coupled to a secure host tenancy 1504 (e.g., the secure host tenancy 1204 of FIG. 12) that can include a virtual cloud network (VCN) 1506 (e.g., the VCN 1206 of FIG. 12) and a secure host subnet 1508 (e.g., the secure host subnet 1208 of FIG. 12). The VCN 1506 can include an LPG 1510 (e.g., the LPG 1210 of FIG. 12) that can be communicatively coupled to an SSH VCN 1512 (e.g., the SSH VCN 1212 of FIG. 12) via an LPG 1510 contained in the SSH VCN 1512. The SSH VCN 1512 can include an SSH subnet 1514 (e.g., the SSH subnet 1214 of FIG. 12), and the SSH VCN 1512 can be communicatively coupled to a control plane VCN 1516 (e.g., the control plane VCN 1216 of FIG. 12) via an LPG 1510 contained in the control plane VCN 1516 and to a data plane VCN 1518 (e.g., the data plane 1218 of FIG. 12) via an LPG 1510 contained in the data plane VCN 1518. The control plane VCN 1516 and the data plane VCN 1518 can be contained in a service tenancy 1519 (e.g., the service tenancy 1219 of FIG. 12).

The control plane VCN 1516 can include a control plane DMZ tier 1520 (e.g., the control plane DMZ tier 1220 of FIG. 12) that can include LB subnet(s) 1522 (e.g., LB subnet(s) 1222 of FIG. 12), a control plane app tier 1524 (e.g., the control plane app tier 1224 of FIG. 12) that can include app subnet(s) 1526 (e.g., app subnet(s) 1226 of FIG. 12), a control plane data tier 1528 (e.g., the control plane data tier 1228 of FIG. 12) that can include DB subnet(s) 1530 (e.g., DB subnet(s) 1430 of FIG. 14). The LB subnet(s) 1522 contained in the control plane DMZ tier 1520 can be communicatively coupled to the app subnet(s) 1526 contained in the control plane app tier 1524 and to an Internet gateway 1534 (e.g., the Internet gateway 1234 of FIG. 12) that can be contained in the control plane VCN 1516, and the app subnet(s) 1526 can be communicatively coupled to the DB subnet(s) 1530 contained in the control plane data tier 1528 and to a service gateway 1536 (e.g., the service gateway of FIG. 12) and a network address translation (NAT) gateway 1538 (e.g., the NAT gateway 1238 of FIG. 12). The control plane VCN 1516 can include the service gateway 1536 and the NAT gateway 1538.

The data plane VCN 1518 can include a data plane app tier 1546 (e.g., the data plane app tier 1246 of FIG. 12), a data plane DMZ tier 1548 (e.g., the data plane DMZ tier 1248 of FIG. 12), and a data plane data tier 1550 (e.g., the data plane data tier 1250 of FIG. 12). The data plane DMZ tier 1548 can include LB subnet(s) 1522 that can be communicatively coupled to trusted app subnet(s) 1560 (e.g., trusted app subnet(s) 1460 of FIG. 14) and untrusted app subnet(s) 1562 (e.g., untrusted app subnet(s) 1462 of FIG. 14) of the data plane app tier 1546 and the Internet gateway 1534 contained in the data plane VCN 1518. The trusted app subnet(s) 1560 can be communicatively coupled to the service gateway 1536 contained in the data plane VCN 1518, the NAT gateway 1538 contained in the data plane VCN 1518, and DB subnet(s) 1530 contained in the data plane data tier 1550. The untrusted app subnet(s) 1562 can be communicatively coupled to the service gateway 1536 contained in the data plane VCN 1518 and DB subnet(s) 1530 contained in the data plane data tier 1550. The data plane data tier 1550 can include DB subnet(s) 1530 that can be communicatively coupled to the service gateway 1536 contained in the data plane VCN 1518.

The untrusted app subnet(s) 1562 can include primary VNICs 1564(1)-(N) that can be communicatively coupled to tenant virtual machines (VMs) 1566(1)-(N) residing within the untrusted app subnet(s) 1562. Each tenant VM 1566(1)-(N) can run code in a respective container 1567(1)-(N), and be communicatively coupled to an app subnet 1526 that can be contained in a data plane app tier 1546 that can be contained in a container egress VCN 1568. Respective secondary VNICs 1572(1)-(N) can facilitate communication between the untrusted app subnet(s) 1562 contained in the data plane VCN 1518 and the app subnet contained in the container egress VCN 1568. The container egress VCN can include a NAT gateway 1538 that can be communicatively coupled to public Internet 1554 (e.g., public Internet 1254 of FIG. 12).

The Internet gateway 1534 contained in the control plane VCN 1516 and contained in the data plane VCN 1518 can be communicatively coupled to a metadata management service 1552 (e.g., the metadata management system 1252 of FIG. 12) that can be communicatively coupled to public Internet 1554. Public Internet 1554 can be communicatively coupled to the NAT gateway 1538 contained in the control plane VCN 1516 and contained in the data plane VCN 1518. The service gateway 1536 contained in the control plane VCN 1516 and contained in the data plane VCN 1518 can be communicatively couple to cloud services 1556.

In some examples, the pattern illustrated by the architecture of block diagram 1500 of FIG. 15 may be considered an exception to the pattern illustrated by the architecture of block diagram 1400 of FIG. 14 and may be desirable for a customer of the IaaS provider if the IaaS provider cannot directly communicate with the customer (e.g., a disconnected region). The respective containers 1567(1)-(N) that are contained in the VMs 1566(1)-(N) for each customer can be accessed in real-time by the customer. The containers 1567(1)-(N) may be configured to make calls to respective secondary VNICs 1572(1)-(N) contained in app subnet(s) 1526 of the data plane app tier 1546 that can be contained in the container egress VCN 1568. The secondary VNICs 1572(1)-(N) can transmit the calls to the NAT gateway 1538 that may transmit the calls to public Internet 1554. In this example, the containers 1567(1)-(N) that can be accessed in real-time by the customer can be isolated from the control plane VCN 1516 and can be isolated from other entities contained in the data plane VCN 1518. The containers 1567(1)-(N) may also be isolated from resources from other customers.

In other examples, the customer can use the containers 1567(1)-(N) to call cloud services 1556. In this example, the customer may run code in the containers 1567(1)-(N) that requests a service from cloud services 1556. The containers 1567(1)-(N) can transmit this request to the secondary VNICs 1572(1)-(N) that can transmit the request to the NAT gateway that can transmit the request to public Internet 1554. Public Internet 1554 can transmit the request to LB subnet(s) 1522 contained in the control plane VCN 1516 via the Internet gateway 1534. In response to determining the request is valid, the LB subnet(s) can transmit the request to app subnet(s) 1526 that can transmit the request to cloud services 1556 via the service gateway 1536.

It should be appreciated that IaaS architectures 1200, 1300, 1400, 1500 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

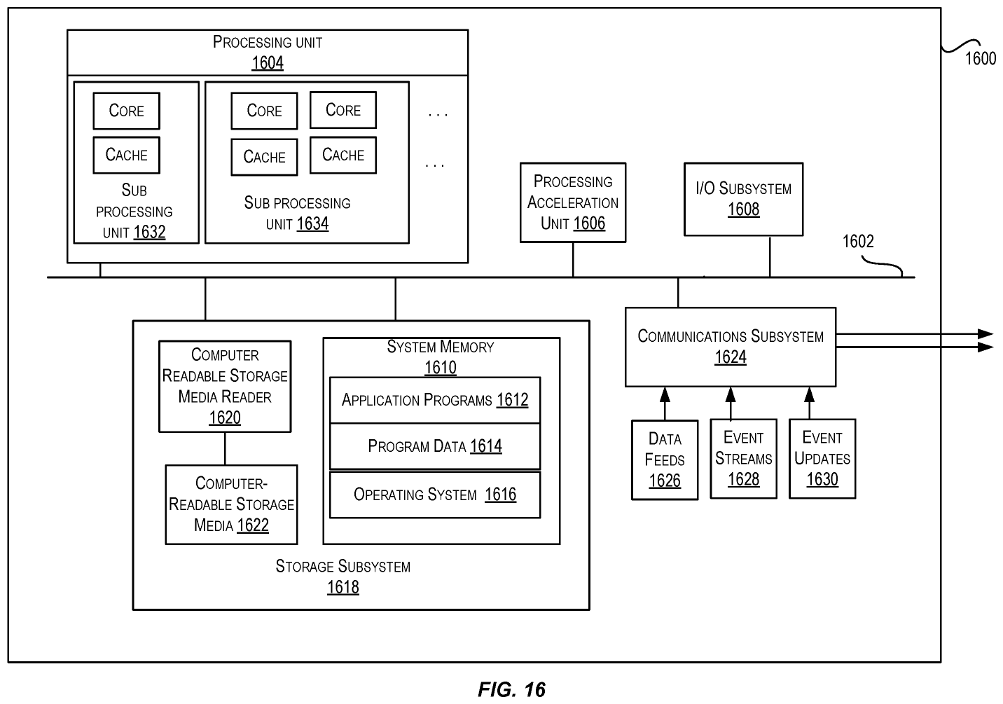

FIG. 16 illustrates an example computer system 1600, in which various embodiments may be implemented. The system 1600 may be used to implement any of the computer systems described above. As shown in the figure, computer system 1600 includes a processing unit 1604 that communicates with a number of peripheral subsystems via a bus subsystem 1602. These peripheral subsystems may include a processing acceleration unit 1606, an I/O subsystem 1608, a storage subsystem 1618 and a communications subsystem 1624. Storage subsystem 1618 includes tangible computer-readable storage media 1622 and a system memory 1610.

Bus subsystem 1602 provides a mechanism for letting the various components and subsystems of computer system 1600 communicate with each other as intended. Although bus subsystem 1602 is shown schematically as a single bus, alternative embodiments of the bus subsystem may utilize multiple buses. Bus subsystem 1602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1604, which can be implemented as one or more integrated circuits (e.g., a conventional microprocessor or microcontroller), controls the operation of computer system 1600. One or more processors may be included in processing unit 1604. These processors may include single core or multicore processors. In certain embodiments, processing unit 1604 may be implemented as one or more independent processing units 1632 and/or 1634 with single or multicore processors included in each processing unit. In other embodiments, processing unit 1604 may also be implemented as a quad-core processing unit formed by integrating two dual-core processors into a single chip.

In various embodiments, processing unit 1604 can execute a variety of programs in response to program code and can maintain multiple concurrently executing programs or processes. At any given time, some or all of the program code to be executed can be resident in processor(s) 1604 and/or in storage subsystem 1618. Through suitable programming, processor(s) 1604 can provide various functionalities described above. Computer system 1600 may additionally include a processing acceleration unit 1606, which can include a digital signal processor (DSP), a special-purpose processor, and/or the like.

I/O subsystem 1608 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1600 may comprise a storage subsystem 1618 that comprises software elements, shown as being currently located within a system memory 1610. System memory 1610 may store program instructions that are loadable and executable on processing unit 1604, as well as data generated during the execution of these programs.

Depending on the configuration and type of computer system 1600, system memory 1610 may be volatile (such as random access memory (RAM)) and/or non-volatile (such as read-only memory (ROM), flash memory, etc.) The RAM typically contains data and/or program services that are immediately accessible to and/or presently being operated and executed by processing unit 1604. In some implementations, system memory 1610 may include multiple different types of memory, such as static random access memory (SRAM) or dynamic random access memory (DRAM). In some implementations, a basic input/output system (BIOS), containing the basic routines that help to transfer information between elements within computer system 1600, such as during start-up, may typically be stored in the ROM. By way of example, and not limitation, system memory 1610 also illustrates application programs 1612, which may include client applications, Web browsers, mid-tier applications, relational database management systems (RDBMS), etc., program data 1614, and an operating system 1616. By way of example, operating system 1616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1618 may also provide a tangible computer-readable storage medium for storing the basic programming and data constructs that provide the functionality of some embodiments. Software (programs, code services, instructions) that when executed by a processor provide the functionality described above may be stored in storage subsystem 1618. These software services or instructions may be executed by processing unit 1604. Storage subsystem 1618 may also provide a repository for storing data used in accordance with the present disclosure.

Storage subsystem 1600 may also include a computer-readable storage media reader 1620 that can further be connected to computer-readable storage media 1622. Together and, optionally, in combination with system memory 1610, computer-readable storage media 1622 may comprehensively represent remote, local, fixed, and/or removable storage devices plus storage media for temporarily and/or more permanently containing, storing, transmitting, and retrieving computer-readable information.

Computer-readable storage media 1622 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1600.

By way of example, computer-readable storage media 1622 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1622 may include, but is not limited to, Zip® drives, flash memory cards, universal serial bus (USB) flash drives, secure digital (SD) cards, DVD disks, digital video tape, and the like. Computer-readable storage media 1622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 1600.

Communications subsystem 1624 provides an interface to other computer systems and networks. Communications subsystem 1624 serves as an interface for receiving data from and transmitting data to other systems from computer system 1600. For example, communications subsystem 1624 may enable computer system 1600 to connect to one or more devices via the Internet. In some embodiments communications subsystem 1624 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1624 can provide wired network connectivity (e.g., Ethernet) in addition to or instead of a wireless interface.

In some embodiments, communications subsystem 1624 may also receive input communication in the form of structured and/or unstructured data feeds 1626, event streams 1628, event updates 1630, and the like on behalf of one or more users who may use computer system 1600.

By way of example, communications subsystem 1624 may be configured to receive data feeds 1626 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1624 may also be configured to receive data in the form of continuous data streams, which may include event streams 1628 of real-time events and/or event updates 1630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1624 may also be configured to output the structured and/or unstructured data feeds 1626, event streams 1628, event updates 1630, and the like to one or more databases that may be in communication with one or more streaming data source computers coupled to computer system 1600.

Computer system 1600 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1600 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
determining, by a computing system, a first time series comprising a first set of data points;
determining, by the computing system, a first change point of the first time series based at least in part on a first relative position of the first change point in the first time series and a category of the first change point;
determining, by the computing system, a second change point of the first time series based at least in part on a second relative position of the second change point in the first time series and a category of the second change point;
generating, by the computing system, a first truncated time series based at least in part on the first change point, the first truncated time series comprising a first subset of data points of the first time series ranging from the first change point to a youngest data point of the first time series;
generating, by the computing system, a second truncated time series based at least in part on the second change point, the second truncated time series comprising a second subset of data points of the first time series ranging from the second change point to the youngest data point of the first time series;
generating, by the computing system, a first forecasted value using a first forecasting technique and the first truncated time series;
generating, by the computing system, a second forecasted value using a second forecasting technique and the second truncated time series;
comparing, by the computing system, the first forecasted value and the second forecasted value using a second time series;
selecting, by the computing system, the first forecasting technique or the second forecasting technique to generate a final forecasted value based at least in part on the comparison; and
based, at least in part, on the first truncated time series and the second truncated time series, generating, by the computing system and using the selected first forecasting technique or second forecasting technique, the final forecasted value.

2. The method of claim 1, wherein determining the first change point of the first time series comprises:
determining a first confidence score for a first candidate change point;
determining a first relative position score for the first candidate change point based at least in part on the relative position of the first candidate change point in the first time series;
determining a first category score of the first candidate change point based at least in part on a first change point category;
determining an average of the first confidence score, the first relative position score, and the first category score to generate a first overall score of the first candidate change point;
comparing the first overall score of the first candidate change point to a second overall score of a second candidate change point; and
selecting the first candidate change point to be the first change point based at least in part on the comparison.

3. The method of claim 2, wherein the first overall score is normalized overall score with respect to a second overall score.

4. The method of claim 1, wherein method further comprises:
determining the first time series and the second time series by:
selecting a data point of a third time series based at least in part on avoidance of a forecasting bias; and
splitting the third time series into the first time series and the second time series based at least in part on the selected data point, the first time series comprising a training set of data points, the second time series comprising a testing set of data points.

5. The method of claim 1, wherein generating the first truncated time series comprises splitting the first time series at the first change point.

6. The method of claim 1, wherein the first forecasting technique is selected, and wherein generating the final forecasted value comprises:
determining a final truncated time series based at least in part on combining the selected first truncated time series with the second time series;
extracting input features from the final truncated time series; and
forecasting the final forecasted value based at least in part on the input features.

7. The method of claim 1, wherein the first forecasting technique comprises Prophet, autoregressive integrated moving average (ARIMA), deep learning-based forecasting, and machine learning-based forecasting.

8. A computing system, comprising:
one or more processors; and
a computer-readable medium including instructions that, when executed by the one or more processors, cause the one or more processors to perform operations comprising:
determining a first time series comprising a first set of data points;
determining a first change point of the first time series based at least in part on a first relative position of the first change point in the first time series and a category of the first change point;
determining a second change point of the first time series based at least in part on a second relative position of the second change point in the first time series and a category of the second change point;
generating a first truncated time series based at least in part on the first change point, the first truncated time series comprising a first subset of data points of the first time series ranging from the first change point to a youngest data point of the first time series;
generating a second truncated time series based at least in part on the second change point, the second truncated time series comprising a second subset of data points of the first time series ranging from the second change point to the youngest data point of the first time series;
generating a first forecasted value using a first forecasting technique and the first truncated time series;
generating a second forecasted value using a second forecasting technique and the second truncated time series;
comparing the first forecasted value and the second forecasted value using a second time series;
selecting the first forecasting technique or the second forecasting technique to generate a final forecasted value based at least in part on the comparison; and
based, at least in part, on the first truncated time series and the second truncated time series, generating, using the selected first forecasting technique or second forecasting technique, the final forecasted value.

9. The computing system of claim 8, wherein determining the first change point of the first time series comprises:
determining a first confidence score for a first candidate change point;
determining a first relative position score for the first candidate change point based at least in part on the relative position of the first candidate change point in the first time series;
determining a first category score of the first candidate change point based at least in part on a first change point category;
determining an average of the first confidence score, the first relative position score, and the first category score to generate a first overall score of the first candidate change point;
comparing the first overall score of the first candidate change point to a second overall score of a second candidate change point; and
selecting the first candidate change point to be the first change point based at least in part on the comparison.

10. The computing system of claim 9, wherein the first overall score is normalized overall score with respect to a second overall score.

11. The computing system of claim 8, wherein the instructions that, when executed by the one or more processors, further cause performance of operations comprising:
determining the first time series and the second time series by:
selecting a data point of a third time series based at least in part on avoidance of a forecasting bias; and
splitting the third time series into the first time series and the second time series based at least in part on the selected data point, the first time series comprising a training set of data points, the second time series comprising a testing set of data points.

12. The computing system of claim 8, wherein generating the first truncated time series comprises splitting the first time series at the first change point.

13. The computing system of claim 8, wherein the first forecasting technique is selected, and wherein generating the final forecasted value comprises:
determining a final truncated time series based at least in part on combining the selected first truncated time series with the second time series;
extracting input features from the final truncated time series; and
forecasting the final forecasted value based at least in part on the input features.

14. The computing system of claim 8, wherein the first forecasting technique comprises Prophet, autoregressive integrated moving average (ARIMA), deep learning-based forecasting, and machine learning-based forecasting

15. A non-transitory computer-readable medium including stored thereon a sequence of instructions that, when executed by one or more processors, causes performance of operations comprising:
determining a first time series comprising a first set of data points;
determining a first change point of the first time series based at least in part on a first relative position of the first change point in the first time series and a category of the first change point;
determining a second change point of the first time series based at least in part on a second relative position of the second change point in the first time series and a category of the second change point;
generating a first truncated time series based at least in part on the first change point, the first truncated time series comprising a first subset of data points of the first time series ranging from the first change point to a youngest data point of the first time series;
generating a second truncated time series based at least in part on the second change point, the second truncated time series comprising a second subset of data points of the first time series ranging from the second change point to the youngest data point of the first time series;
generating a first forecasted value using a first forecasting technique and the first truncated time series;
generating a second forecasted value using a second forecasting technique and the second truncated time series;
comparing the first forecasted value and the second forecasted value using a second time series;
selecting the first forecasting technique or the second forecasting technique to generate a final forecasted value based at least in part on the comparison; and
based, at least in part, on the first truncated time series and the second truncated time series, generating, using the selected first forecasting technique or second forecasting technique, the final forecasted value.

16. The non-transitory computer-readable medium of claim 15, wherein
determining the first change point of the first time series comprises:
determining a first confidence score for a first candidate change point;
determining a first relative position score for the first candidate change point based at least in part on the relative position of the first candidate change point in the first time series;
determining a first category score of the first candidate change point based at least in part on a first change point category;
determining an average of the first confidence score, the first relative position score, and the first category score to generate a first overall score of the first candidate change point;
comparing the first overall score of the first candidate change point to a second overall score of a second candidate change point; and
selecting the first candidate change point to be the first change point based at least in part on the comparison.

17. The non-transitory computer-readable medium of claim 16, wherein the first overall score is normalized overall score with respect to a second overall score.

18. The non-transitory computer-readable medium of claim 15, wherein the instructions that, when executed by the one or more processors, further cause performance of operations comprising:
determining the first time series and the second time series by:
selecting a data point of a third time series based at least in part on avoidance of a forecasting bias; and
splitting the third time series into the first time series and the second time series based at least in part on the selected data point, the first time series comprising a training set of data points, the second time series comprising a testing set of data points.

19. The non-transitory computer-readable medium of claim 15, wherein
generating the first truncated time series comprises splitting the first time series at the first change point.

20. The non-transitory computer-readable medium of claim 15, wherein the first forecasting technique is selected, and wherein generating the final forecasted value comprises:
determining a final truncated time series based at least in part on combining the selected first truncated time series with the second time series;
extracting input features from the final truncated time series; and
forecasting the final forecasted value based at least in part on the input features.
